(19) United States
(12) Patent Application Publication
(10) Pub. No.: US 2019/0387550 A1
(43) Pub. Date: Dec. 19, 2019

(54) PHYSICAL BROADCAST CHANNEL, INITIAL UPLINK TRANSMISSION AND SYSTEM ACQUISITION ASSOCIATED WITH NEW RADIO

(71) Applicant: IDAC Holdings, Inc., Wilmington, DE (US)

(72) Inventors: Kyle Jung-Lin Pan, Saint James, NY (US); Fengjun Xi, San Diego, CA (US); Robert L. Olesen, Huntington, NY (US)

(73) Assignee: IDAC Holdings, Inc., Wilmington, DE (US)

(21) Appl. No.: 16/473,241

(22) PCT Filed: Jan. 4, 2018
(86) PCT No.: PCT/US2018/012295

§ 371 Date: Jun. 24, 2019

Related U.S. Application Data
(60) Provisional application No. 62/519,654, filed on Jun. 14, 2017.
(60) Provisional application No. 62/500,986, filed on May 3, 2017.
(60) Provisional application No. 62/454,546, filed on Feb. 3, 2017.
(60) Provisional application No. 62/443,261, filed on Jan. 6, 2017.

(51) Int. Cl. H04W 74/08; H04W 74/02; H04L 5/00; H04L 27/26

(52) U.S. Cl. CPC H04W 74/0833; H04L 27/2607; H04L 5/0094; H04W 74/02

(57) ABSTRACT

Systems, methods, and instrumentalities are disclosed for NR-PBCH, initial uplink (UL) transmission and system acquisition in NR, including procedures for system acquisition, initial UL transmission, cell ID detection, indicating an SS-block Index and determining subframe timing. A WTRU may receive a first part of minimum system information. The first part of minimum system information (MSI) may include subcarrier spacing (SCS) information associated with a second part of MSI. The WTRU may receive the second part of MSI. The second part of MSI may include information associated with transmitting a physical random access channel (PRACH) request (e.g., PRACH preamble, SCS information, orthogonal cover code (OCC)). The WTRU may configure a PRACH request. The PRACH request may follow a first or a second configuration. The PRACH request may include a cyclic prefix (CP), a guard time (GT), and one or more preamble sequences. The preamble sequences may be repeated.

### CROSS-REFERENCE TO RELATED APPLICATIONS

This application claims priority from: U.S. Provisional Patent Application No. 62/443,261, filed Jan. 6, 2017; U.S. Provisional Patent Application No. 62/454,546, filed Feb. 3, 2017; U.S. Provisional Patent Application No. 62/500,986, filed May 3, 2017; and U.S. Provisional Patent Application No. 62/519,654, filed Jun. 14, 2017.

### BACKGROUND

Mobile communications continue to evolve. A fifth generation may be referred to as 5G. A previous (legacy) generation of mobile communication may be, for example, fourth generation (4G) long term evolution (LTE). Mobile wireless communications implement a variety of radio access technologies (RATs), such as New Radio (NR). Use cases for NR may include, for example, extreme Mobile Broadband (eMBB), Ultra High Reliability and Low Latency Communications (URLLC) and massive Machine Type Communications (mMTC).

### SUMMARY

Systems, methods, and instrumentalities are disclosed for NR-physical broadcast channel (PBCH), initial uplink (UL) transmission and system acquisition in NR, including procedures for system acquisition, initial UL transmission, cell identification (ID) detection, indicating an SS-block Index and determining subframe timing, and secondary new radio physical broadcast channel (NR-PBCH) designs.

A PBCH may be used by a Wireless Transmit/Receive Unit (WTRU) for system acquisition. The WTRU may provide for transmission in the PBCH, first and second parts of minimum system information, the second part of the minimum system information comprising time domain scheduling information for transmission of a system information block (SIB) beyond minimum system information. The WTRU may provide for transmission in a Physical Downlink Control Channel (PDCCH), frequency domain scheduling information for the transmission of the SIB. The WTRU may provide for transmission in the PBCH, a first part of minimum system information. The WTRU may provide for transmission in a secondary PBCH and/or PDSCH, a second part of minimum system information comprising time domain scheduling information for transmission of a system information block (SIB) beyond minimum system information. The WTRU may provide for transmission in a Physical Downlink Control Channel (PDCCH), frequency domain scheduling information for the transmission of the SIB. The WTRU may provide for transmission in the PBCH, a first part of minimum system information comprising scheduling information for transmission by a downlink (DL) response channel. The WTRU may provide for transmission in the DL response channel, responsive to initial uplink transmission from the WTRU, a second part of minimum system information.

A subcarrier spacing or numerology for a second part of minimum system information or remaining minimum system information may be determined based on an indicator. The indicator may comprise an NR-PBCH, NR-PBCH demodulation reference signal (DMRS), and/or NR-PBCH subcarrier spacing.

An SS-block index may be determined implicitly, for example, via various sequences or shifts of DMRS. A transmission of different known sequences of DMRS may indicate different SS-block indices. For example, a sequence of DMRS may comprise two m sequences multiplied or XORed with each other. The two m sequences may be generated by predetermined polynomials.

### BRIEF DESCRIPTION OF THE DRAWINGS

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network (RAN) and an example core network (CN) that may be used within the communications system illustrated in FIG. 1A.

FIG. 1D is a system diagram of further example RAN and a further example CN that may be used within the communications system illustrated in FIG. 1A.

FIG. 2 is an example of new radio physical broadcast channel (NR-PBCH) carrying first and second parts of minimum system information.

FIG. 3 is an example of NR-PBCH carrying a first part of minimum system information.

FIG. 4 is an example of NR-PBCH carrying a first part of minimum system information.

FIG. 5 is an example of NR-PBCH carrying a first part of minimum system information.

FIG. 6 is an example of a Broadcast Channel for Initial UL transmission.

FIG. 7 is an example of a Broadcast Channel for Initial UL transmission.

FIG. 8 is an example of a physical initial uplink transmission channel (PIUCH).

FIG. 9 is an example of a PIUCH.

FIG. 10 is an example of a PIUCH.

FIG. 11 is an example of configuring an initial uplink transmission.

FIGS. 12A and 12B are an example of an initial uplink response.

FIG. 13 is an example of an initial uplink transmission sequence.

FIG. 14 is an example of an initial uplink transmission sequence.

FIG. 15 is an example of an initial uplink transmission sequence.

FIG. 16 is an example of an initial uplink transmission sequence.

FIG. 17 is an example of an initial uplink transmission sequence.

FIG. 18 is an example of an initial uplink transmission sequence.

FIG. 19 is an example of an initial uplink transmission sequence.

FIG. 20 is an example of an initial uplink transmission sequence.

FIG. 21 is an example of an initial uplink transmission sequence.

FIG. 22 is an example of an initial uplink transmission sequence.

FIG. 23 is an example of an initial uplink transmission sequence.

FIG. 24 is an example of an initial uplink transmission sequence.

FIG. 25 is an example of an initial uplink transmission sequence.

FIG. 26 is an example of system information delivery to enable initial uplink or physical random access channel (PRACH) transmission.

FIG. 27 is an example of a cell ID detection.

FIG. 28 is an example of a Cell ID detection.

FIG. 29 is an example of a cell ID detection with confirmation.

FIG. 30 is an example of a cell ID detection.

FIG. 31 is an example of a cell ID detection.

FIG. 32 is an example of a synchronization signal (SS)-block and subframe timing.

FIG. 33 is an example procedure using an NR-PBCH to indicate an SS-Block Index and determine subframe timing.

FIG. 34 is an example of a secondary NR-PBCH assisting NR-PBCH to acquire minimum system information.

FIG. 35 is an example of a secondary NR-PBCH transmission.

FIG. 36 is an example of secondary NR broadcast channel coding.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

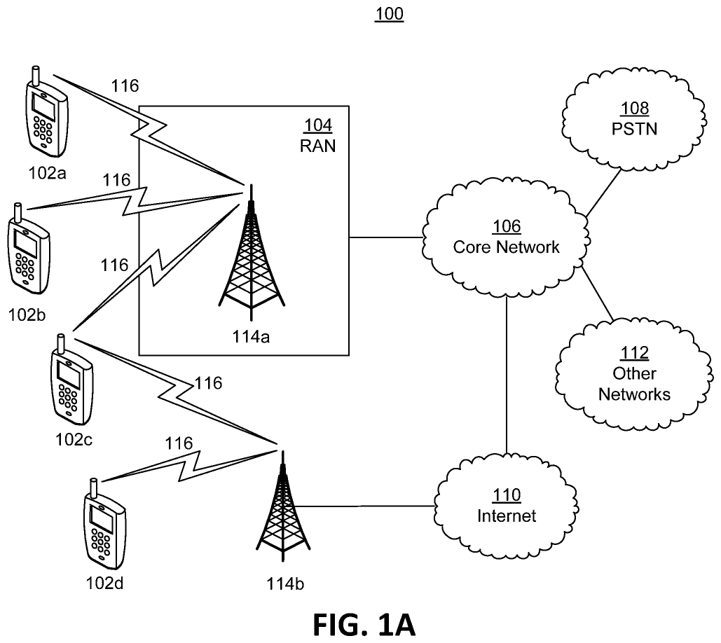

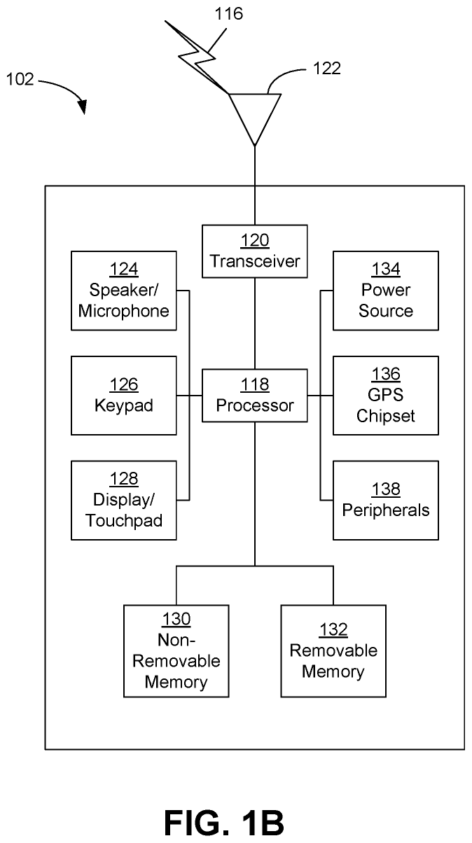

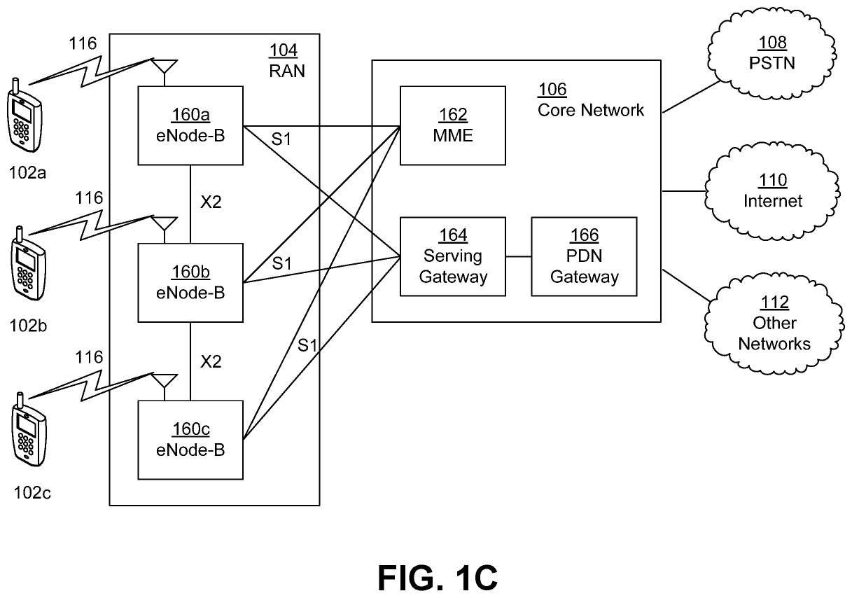

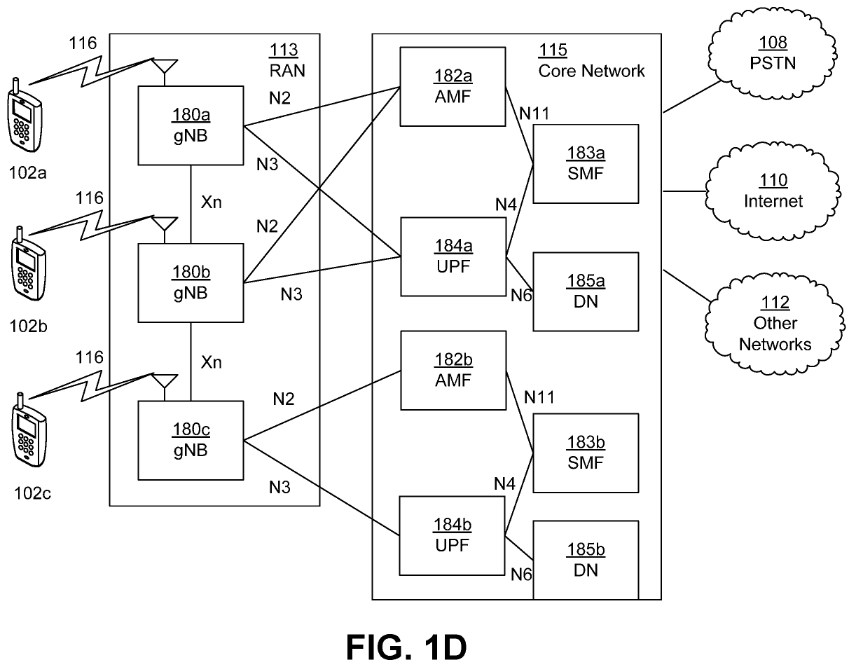

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement M IMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement M IMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIG. 1A-1D, and the corresponding description of FIG. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Beamforming may be implemented, for example, in 5G New Radio (NR).

A broad classification of use cases for 5G systems may include, for example, Enhanced Mobile Broadband (eMBB), Massive Machine Type Communications (mMTC) and Ultra Reliable and Low Latency Communications (URLLC). Different use cases may have different requirements, such as higher data rate, higher spectrum efficiency, lower power and higher energy efficiency, lower latency and higher reliability. A wide range of spectrum bands (e.g., ranging from 700 MHz to 80 GHz) may be utilized in a variety of deployment scenarios.

Severe path loss may limit coverage area, for example, as carrier frequency increases. Transmission in millimeter wave systems may incur non-line-of-sight losses, e.g., diffraction loss, penetration loss, Oxygen absorption loss, foliage loss, etc. A base station and WTRU may (e.g., during initial access) overcome high path losses and discover each other. Utilizing dozens or even hundreds of antenna elements to generated beam formed signal may be an effective way to compensate for severe path loss, e.g., by providing significant beam forming gain. Beamforming techniques may include, for example, digital, analog and hybrid beamforming.

Initial synchronization and a broadcast channel may be implemented, for example, in LTE.

A WTRU may (e.g., during a cell search procedure) acquire time and frequency synchronization with a cell and may detect a Cell ID of a cell. Synchronization signals may be transmitted (e.g., in LTE), for example, in the 0th and 5th subframes of a (e.g., every) radio frame and may be used for time and frequency synchronization (e.g., during initialization). A WTRU may (e.g., as part of a system acquisition process) synchronize (e.g., sequentially) to an OFDM symbol (e.g., sequence), slot, subframe, half-frame and radio frame (e.g., based on synchronization signals). Synchronization signals may include, for example, Primary Synchronization Signal (PSS) and Secondary Synchronization Signal (SSS).

PSS may be used, for example, to obtain a symbol, slot, subframe and half-frame boundary. PSS may (e.g., also) provide physical layer cell identity (PCI) within a cell identity group.

SSS may be used, for example, to obtain a radio frame boundary. SSS may (e.g., also) enable a WTRU to determine a cell identity group (e.g., a range from 0 to 167).

A WTRU may (e.g., following a successful synchronization and PCI acquisition) decode a Physical Broadcast Channel (PBCH), for example, with the help of CRS. A WTRU may (e.g., also) acquire master information block (MIB) information, e.g., regarding system bandwidth, System Frame Number (SFN) and PHICH configuration.

LTE synchronization signals and PBCH may be transmitted continuously, for example, according to standardized periodicity.

A new radio physical broadcast channel (NR-PBCH) may carry a part of minimum system information. Minimum system information may include, for example, one or more of the following alone or in any combination (e.g., in addition to those included in NR-PBCH).

In examples, NR may define an additional channel as a secondary broadcast channel. A secondary broadcast channel may be different from NR-PBCH, e.g., payload size, resource mapping, periodicity, etc.

Minimum system information (MSI) may include MIB and remaining system information (RMSI). A first part of MSI may include an MIB. The first part of MSI may be carried by an NR-PBCH. A second part of MSI may include RMSI. The second part of MSU may be carried by a New Radio Physical Downlink Shared Channel (NR-PDSCH). In examples, minimum system information (e.g., the RMSI) may be transmitted in a shared downlink channel (e.g., similar to NR-PDSCH).

NR may provide a minimum system information transmission to a WTRU. NR-PBCH may be a non-scheduled broadcast channel, which may carry at least a part of minimum system information, for example, with fixed payload size and periodicity predefined, e.g., depending on carrier frequency range.

In examples, NR-PBCH may carry a part of minimum system information. For example, the remaining minimum system information may be transmitted to the WTRU via another channel, e.g., that may be at least partially indicated by NR-PBCH. The remaining minimum system information may be transmitted via another channel that may not be indicated in NR-PBCH.

In examples, NR-PBCH may carry all minimum system information.

A physical broadcast channel design, e.g., associated with new radio (NR), may be provided such that it implements one or more of the following: (i) carries minimum system information; (ii) configures an initial uplink transmission; (iii) configures a DL response channel (e.g., in response to initial UL transmission); (iv) indicates an SS-block index and/or cell ID acquisition. A secondary broadcast channel design, e.g., associated with NR, may be provided.

System information (e.g., MIB, RMSI, and other system information (OSI)) may be transmitted (e.g., broadcast) by one or more channels, such as one or more of the following (e.g., alone or in any combination): NR-PBCH, DL Response Channel (e.g., in response to Initial UL Transmission), secondary NR-PBCH and/or scheduled SI NR-PDCCH/NR-PDSCH.

A NR-PBCH for system acquisition may be provided. One or more of the following may apply.

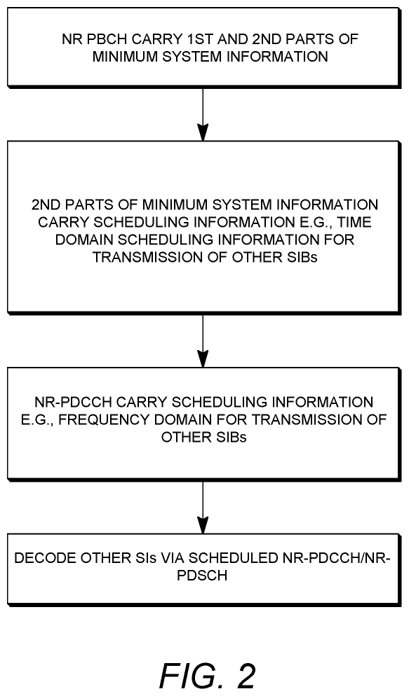

NR-PBCH may carry first and second parts of minimum system information. FIG. 2 is an example of NR-PBCH carrying first and second parts of minimum system information. Other system information (e.g., beyond minimum system information) may be scheduled by a second part of minimum system information. The second part of minimum system information may carry configuration information or time domain scheduling information, e.g., for transmitting system information beyond minimum system information. Configuration information may include one or more of a control resource set, a common search space, a common search space segment or partition, and/or the like.

A New Radio Physical Downlink Control Channel (NR-PDCCH) may carry frequency domain scheduling information, e.g., for transmitting system information beyond minimum system information via NR-PDSCH. A WTRU may decode NR-PDCCH, for example, with New Radio System Information Radio Network Temporary Identifier (NR-SI-RNTI) to decode NR-PDSCH in one or more scheduled time domain TTls.

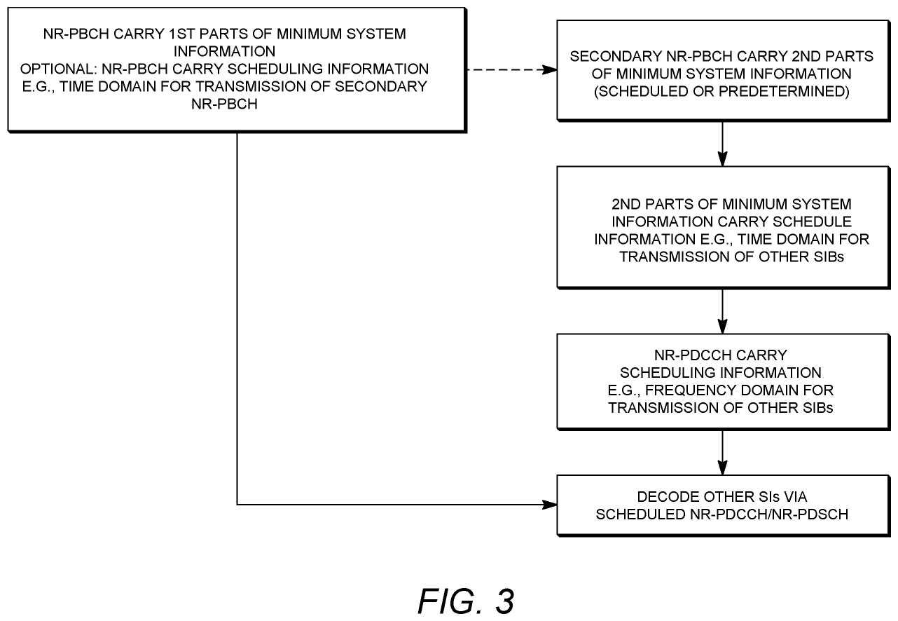

NR-PBCH may carry a first part of minimum system information. FIG. 3 is an example of NR-PBCH carrying a first part of minimum system information. A secondary NR-PBCH may carry a second part of minimum system information, which may not be scheduled by NR-PBCH. Configuration information or scheduling information such as time or frequency domain scheduling may be predetermined for secondary NR-PBCH. Configuration information may include one or more of a control resource set, a common search space, a common search space segment or partition, and/or the like. System information beyond minimum system information may be scheduled by a second part of minimum system information. The second part of minimum system information may carry configuration information or time domain scheduling information, e.g., for transmitting system information beyond minimum system information. Configuration information may include one or more of a control resource set, a common search space, a common search space segment or partition, and/or the like. NR-PDCCH may carry frequency domain scheduling information for transmitting system information beyond minimum system information, e.g., via NR-PDSCH. A WTRU may decode NR-PDCCH, for example, using its NR-SI-RNTI to decode NR-PDSCH in one or more scheduled time domain TTls.

NR-PBCH may carry a first part of minimum system information. One or more of the following may apply.

A secondary NR-PBCH may carry a second part of minimum system information. NR-PBCH may carry configuration information or scheduling information (e.g., time domain scheduling information) for transmitting a second part of minimum system information on the secondary NR-PBCH. NR-PBCH may (e.g., also) carry configuration information or scheduling information (e.g., frequency domain scheduling information) for transmitting a second part of minimum system information on the secondary NR-PBCH. Frequency domain scheduling may (e.g., alternatively) be predetermined for the secondary NR-PBCH. Configuration information may include one or more of a control resource set, a common search space, a common search space segment or partition, and/or the like.

System information beyond minimum system information may be scheduled by a second part of minimum system information, which may carry configuration information or time domain scheduling information, e.g., for transmitting system information beyond minimum system information. Configuration information may include one or more of a control resource set, a common search space, a common search space segment or partition, and/or the like. NR-PDCCH may carry frequency domain scheduling information for transmitting system information beyond minimum system information, e.g., via NR-PDSCH. A WTRU may decode NR-PDCCH, for example, using its NR-SI-RNTI to decode NR-PDSCH in one or more scheduled time domain TTIs.

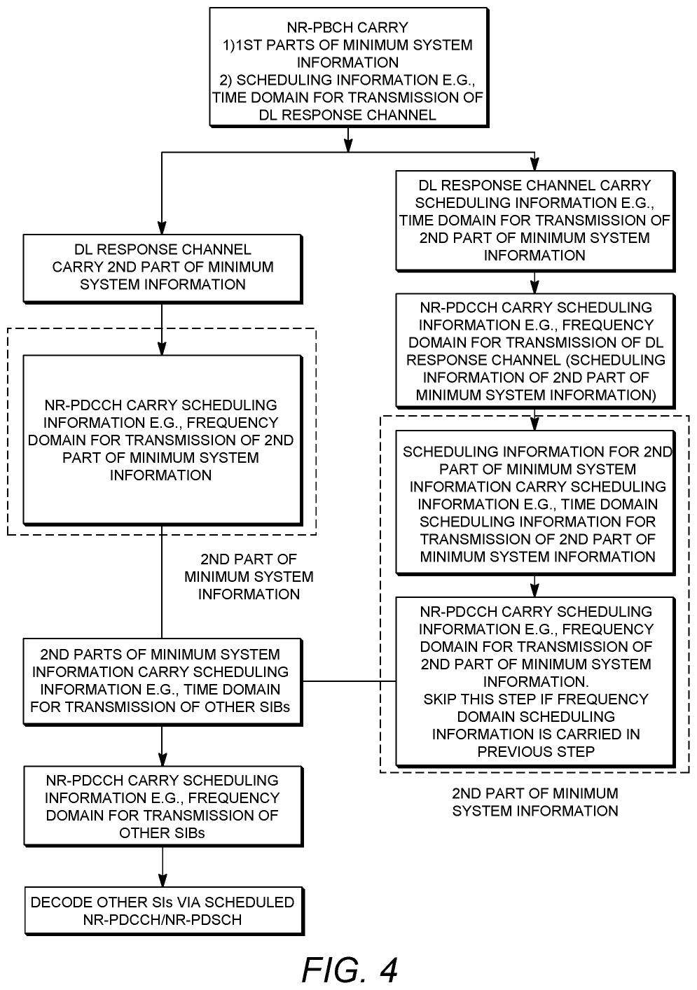

NR-PBCH may carry a first part of minimum system information. FIG. 4 is an example of NR-PBCH carrying a first part of minimum system information. One or more of the following may apply.

NR-PBCH may carry configuration information or scheduling information (e.g., time domain scheduling information) for transmitting a DL response channel (RC), e.g., in response to an initial UL transmission. Configuration information may include one or more of a control resource set, a common search space, a common search space segment or partition, and/or the like. Configuration information may include one or more of a DL response specific control resource set, a common search space, a common search space segment or partition, and/or the like.

A DL Response Channel (e.g., in response to an initial UL transmission) may carry a second part of minimum system information. NR-PDCCH may carry frequency domain configuration information or scheduling information for transmitting on a DL response channel (e.g., in response to an initial UL transmission). The DL response channel may carry a second part of minimum system information, e.g., via NR-PDSCH. A WTRU may decode NR-PDCCH, for example, using its NR-RC-RNTI to decode NR-PDSCH in one or more scheduled time domain ills. Configuration information may include one or more of a control resource set, a common search space, a common search space segment or partition, and/or the like. Configuration information may include one or more of a DL response specific control resource set, a common search space, a common search space segment or partition, and/or the like.

A DL Response Channel (e.g., to initial UL transmission) may (e.g., alternatively) carry configuration information or scheduling information (e.g., time domain scheduling information) for transmission of a second part of minimum system information. NR-PDCCH may carry configuration information or frequency domain scheduling information for transmitting a DL response channel (e.g., to initial UL transmission). The DL response channel may carry configuration information or scheduling information (e.g., time domain scheduling information) for transmission of a second part of minimum system information, e.g., via NR-PDSCH. A WTRU may decode the NR-PDCCH, for example, using its NR-RC-RNTI to decode the NR-PDSCH in one or more of the scheduled time domain ills carried by the DL Response Channel. Configuration information may include one or more of a control resource set, a common search space, a common search space segment or partition, and/or the like. Configuration information may include one or more of a DL response specific control resource set, a common search space, a common search space segment or partition, and/or the like.

Configuration information or scheduling information for a second part of minimum system information may carry configuration information (e.g., additional configuration information) or scheduling information (e.g., time domain scheduling information) for transmission of a second part of minimum system information (e.g., transmit or receive periodicity, time offset, etc.). Configuration information may include one or more of a control resource set, a common search space, a common search space segment or partition, and/or the like. Configuration information may include one or more of a DL response specific control resource set, a common search space, a common search space segment or partition, and/or the like. NR-PDCCH may carry configuration information or scheduling information (e.g., frequency domain) for transmission of a second part of minimum system information. This may be avoided, for example, when frequency domain scheduling information is carried another way, e.g., as described herein. System information beyond minimum system information may be scheduled by a second part of minimum system information. The second part of minimum system information may carry configuration information or time domain scheduling information, e.g., for transmitting system information beyond minimum system information. NR-PDCCH may carry configuration information or frequency domain scheduling information for transmitting system information beyond minimum system information, e.g., via NR-PDSCH. A WTRU may decode NR-PDCCH, for example, using its NR-SI-RNTI to decode NR-PDSCH in one or more of the scheduled time domain TTls. Configuration information may include one or more of a control resource set, a common search space, a common search space segment or partition, and/or the like. Configuration information may include one or more of a DL response specific control resource set, a common search space, a common search space segment or partition, and/or the like.

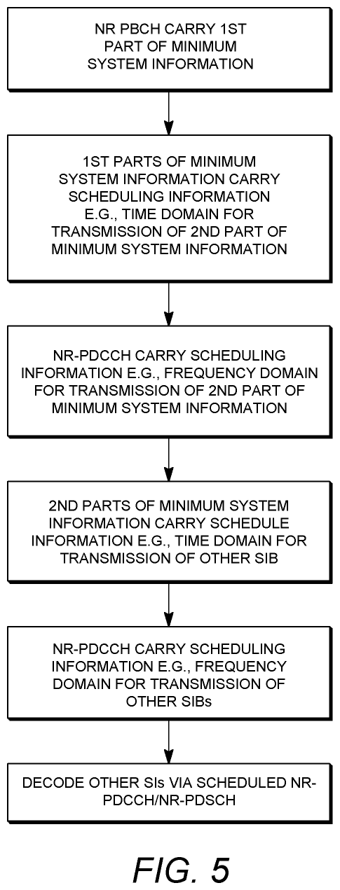

NR-PBCH may be used to carry a first part of minimum system information. FIG. 5 is an example of NR-PBCH carrying a first part of minimum system information. One or more of the following may apply.

NR-PBCH may carry configuration information and/or scheduling information for NR-PDCCH transmission. For example, NR-PDCCH may carry a control resource set, a search space in which the NR-PDCCH may be transmitted, and/or time domain scheduling information in which the NR-PDCCH may be transmitted for scheduling NR-PDSCH to transmit a second part of minimum system information.

An indicator (e.g., an indicator of N bits) for a control resource set may be carried in NR-PBCH payload. Multiple control resource sets may be configured for transmission and reception of the 2^{nd} part of minimum system information and/or remaining minimum system information (RMSI). An indicator (e.g., an indicator of M bits) for multiple control resource sets may be carried in NR-PBCH payload.

The first part of MSI may be a MIB. The second part of MSI may be RMSI. The first part of MSI may be carried in NR-PBCH. The second part of MSI may be carried in NR-PDSCH which may be scheduled (e.g., fully or in part) by NR-PDCCH.

NR-PDCCH may carry configuration information (e.g., full or partial configuration information) or frequency domain scheduling information for scheduling and transmitting a second part of minimum system information (SI), e.g., via NR-PDSCH. A WTRU may decode NR-PDCCH in the configured control resource set(s) and/or search space(s), for example, using its NR-SI-RNTI to decode the NR-PDSCH in one or more scheduled time domain ITIs. Predefined configuration information and/or scheduling information such as frequency domain resources allocation may be used for transmitting a second part of minimum system information (e.g., to reduce configuration and/or scheduling overhead). A set (e.g., an entire set or a subset) of configuration information or scheduling information may be predefined. An indicator (e.g., an indicator one bit long) may be used in NR-PBCH to indicate the presence/absence of NR-PDCCH. An indicator (e.g., an indicator of one bit) may be used in NR-PBCH to indicate the presence/absence of frequency resource allocation, a (e.g., particular) control field(s) or other control field(s) in NR-PDCCH. An indicator (e.g., an indicator of one bit) may be used in NR-PBCH to indicate different types of NR-PDCCH downlink control information (DCI) formats for scheduling and/or transmitting a second part of minimum system information.

System information beyond minimum system information may be scheduled by a second part of minimum system information. The second part of minimum system information may carry configuration information or time domain scheduling information for transmitting system information beyond minimum system information. NR-PDCCH may carry configuration information or frequency domain scheduling information for transmitting system information beyond minimum system information, e.g., via NR-PDSCH. A WTRU may decode NR-PDCCH, for example, using its NR-SI-RNTI to decode NR-PDSCH in one or more of the scheduled time domain ITIs. Configuration information discussed herein (e.g., carried in NR-PBCH and/or NR-PDCCH) may include one or more of a control resource set(s), a common search space(s), a common search space segment(s) or partition(s), or the like.

A variety of types of system information may be transmitted (e.g., may be required for transmission).

In examples, a first part of minimum system information may comprise one or more of the following: PHICH configuration information, a DL bandwidth, system frame number (SFN), or parameters related to multi-beam operations or configurations, and/or numerology (e.g., subcarrier spacing, cyclic prefix, etc.). PHICH configuration information may or may not be included.

In examples, a second part of minimum system information may comprise, for example, system information block 1 (SIB1) and/or system information block 2 (SIB2). SIB1 may comprise, for example, information indicating whether a device may be (e.g., is) allowed to camp on cell, UL/DL configuration of time division duplex (TDD), time-domain scheduling information for remaining system information blocks (SIBs) (e.g., SIB2 and beyond). SIB2 may comprise, for example, information to access one or more cells (e.g., UL bandwidth), random access parameters, parameter(s) for UL power control, etc. A second part of minimum system information may comprise parameters related to multi-beam configurations or operations and/or numerology.

In an example, types of system information that may be transmitted may comprise other system information or SIBs.

Initial UL transmission may be configured by one or more channels, such as one or more of NR-PBCH or Secondary NR-PBCH. Configuration information for the initial UL transmission may comprise one or more of a frequency, time resources. a set of frequency and/or time resources, and/or the like. Configuration information for the initial UL transmission may include one or more of an initial UL transmission specific frequency, a time resources, a set of frequency and/or time resources specific for initial UL transmission, and/or the like.

An initial UL transmission may be used to achieve multi-beam transmissions (e.g., advanced multi-beam transmission) and/or to request system information (e.g., additional system information). A DL response may provide configuration information and/or scheduling information (e.g., necessary scheduling information). The WTRU may use the configuration information and/or the scheduling information to receive information on a channel carrying the 2^{nd} part of the minimum system information (e.g., scheduling information). The initial UL transmission may be used for requesting, enabling, or disabling beam transmissions for system information transmission and/or other channel transmissions (e.g., control, data channel, and/or the like). The initial UL transmission may be used for requesting for system information transmission (e.g., additional system information transmission).

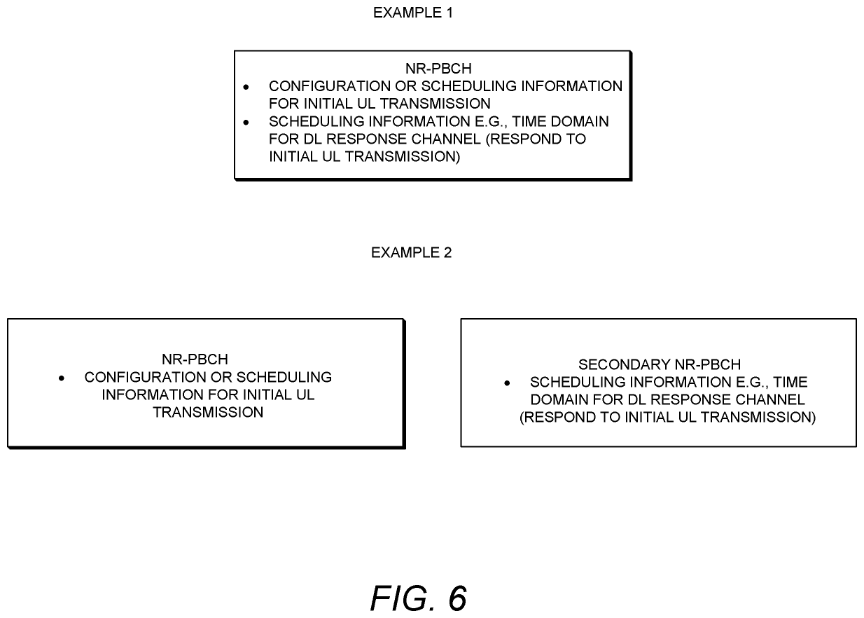

FIG. 6 is an example of a Broadcast Channel for Initial UL transmission. FIG. 6 shows multiple examples.

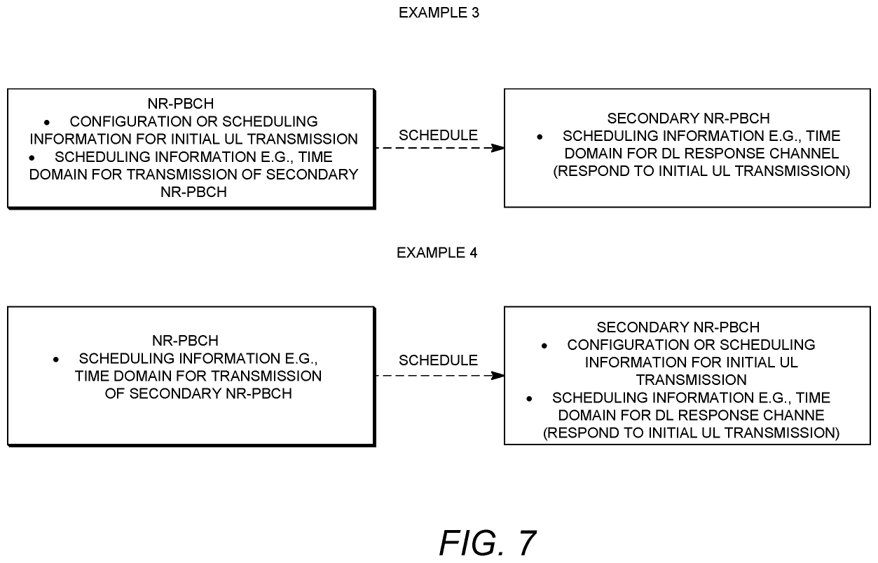

FIG. 7 is an example of a Broadcast Channel for Initial UL transmission. FIG. 7 shows multiple examples.

An eNB may detect one or more preambles transmitted at progressively higher transmit powers. An RAR may be sent (e.g., by an eNB), for example, in response to a detected preamble. A PRACH preamble may be (e.g., considered to be) a PRACH resource. PRACH resources may include, for example, a PRACH preamble, time resources and/or frequency resources. PBCH may be configured for an initial UL transmission. The initial UL transmission may not be limited to NR-PRACH, e.g., PRACH msg. 1.

An initial uplink transmission may comprise transmitting a message. For example, the message may indicate, to a network entity, e.g., gNB/eNB, the presence of an initial UL transmission attempt, may indicate the presence of a WTRU (e.g., for its beam-location profile), and/or may allow a gNB/eNB to estimate a delay between a gNB/eNB and WTRU. A delay estimate may be used (e.g., subsequently) in a random access procedure, e.g., to adjust uplink timing.

A time-frequency resource, on which an initial UL transmission may be transmitted, may be defined as a physical initial uplink transmission channel (PIUCH). A network may broadcast information to multiple (e.g., all) WTRUs in which the time-frequency resource initial uplink transmission may be allowed, e.g., PIUCH resources. A network may broadcast PIUCH resources to WTRUs, for example, by using a broadcast channel, such as NR-PBCH, by using a secondary NR-PBCH, and/or by using a channel such as a NR-PDSCH carrying a second part of minimum system information. A WTRU may select a (e.g., one) preamble to transmit on the PIUCH. A preamble may be selected from, for example, a contention-based set, a contention-free set or a PIUCH set. The preamble selection may depend on one or more of the implementations described herein.

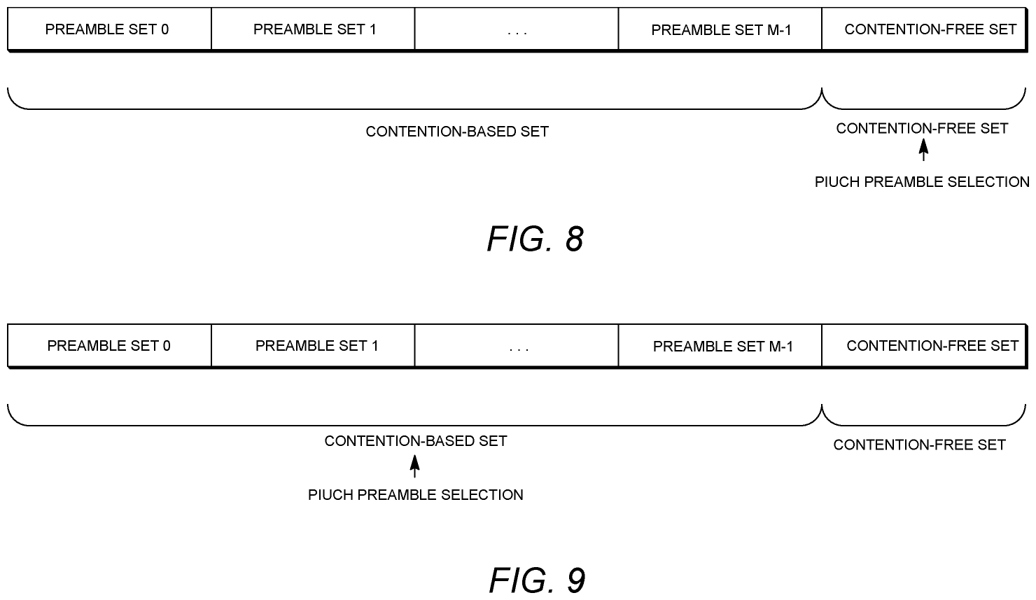

There may be N preamble sequences available in a (e.g., each) NR cell. M subsets of N sequences may be defined, for example, as illustrated in FIG. 8. FIG. 8 is an example of a PIUCH Preamble. A set of sequences, to be used in a (e.g., each) subset, may be signaled to a WTRU by the network, for example, as part of minimum system information or in addition to minimum system information.

A preamble (e.g., a preamble sequence) may be indicated (e.g., explicitly indicated) by a gNB/eNB, for example, when a WTRU may be configured or requested to perform a contention-free initial UL transmission. A gNB/eNB may select a contention-free preamble (e.g., to avoid collisions) from sequences outside M subsets that may be used for contention-based random access. A contention-free preamble may be used to send an initial UL transmission, request beam transmission, report beam failure recovery request, request on demand system information delivery, etc. An example is shown in FIG. 8.

A WTRU may select (e.g., select at random) a (e.g., one) sequence in a (e.g., one) of the subsets, for example, when performing a contention-based initial uplink transmission attempt. Collisions may not occur and an initial UL transmission attempt may be detected by a gNB/eNB with a high likelihood, for example, when another WTRU is not performing a random access attempt using the same sequence at the same time instant.

Collisions may not occur and an initial UL transmission attempt may be detected by a gNB/eNB with a high likelihood, for example, when another WTRU is performing an initial uplink transmission attempt using the same sequence at the same time instant, e.g., given that a common initial UL transmission attempt from (e.g., all) WTRUs may be allowed to request or acknowledge a beam transmission or system information transmission using an initial uplink transmission. A contention-based preamble may be used to send an initial UL transmission. An example is shown in FIG. 9.

FIG. 9 is an example of a PIUCH Preamble. A subset, from which to select a preamble sequence from, may be determined based on the amount of data a WTRU wants to transmit on a DL response channel. The DL response channel may be used to respond to initial UL transmission. A gNB/eNB may be provided with some guidance on the amount of downlink or uplink resources to be granted to a WTRU (e.g., in a system-on-demand procedure), for example, based on the preamble a WTRU may use.

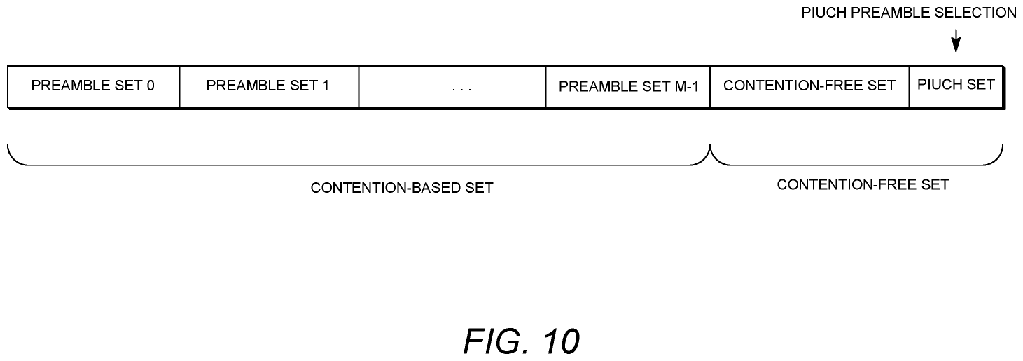

A reserved preamble or a preamble set (e.g., PIUCH set) may be used to (e.g., used to exclusively) send an initial UL transmission. An example is shown in FIG. 10.

FIG. 10 is an example of a PIUCH Preamble. A common preamble (e.g., a single preamble, a reserved preamble, NR-PRACH message 1, or a midamble) may be used for an initial UL transmission. A preamble attached with data payload may (e.g., may also) be used for an initial UL transmission. A midamble attached with data payload may (e.g., may alternatively) be used for an initial UL transmission. PIUCH may carry one or more of a sequence or preamble, a sequence or preamble attached with control information, a sequence or preamble attached with control information and data payload, and/or the like.

Resources may be provided for an initial UL transmission.

A PIUCH resource (e.g., in the frequency domain) may have a bandwidth corresponding to K resource blocks. This may match the smallest uplink cell bandwidth of K resource blocks in which NR may operate. In an example, the same initial UL transmission preamble structure may be used, e.g., regardless of transmission bandwidth in an NR cell.

The length of a preamble region (e.g., in the time domain) may depend on a configured preamble. An initial UL transmission may be X ms in duration. One or more longer preambles may be configured. A gNB/eNB may reserve an arbitrarily long initial UL transmission region, for example, by avoiding scheduling a WTRU in multiple subsequent subframes. A gNB/eNB may avoid scheduling uplink transmissions in the time-frequency resources used for initial uplink transmission, which may result in an initial uplink transmission preamble being orthogonal to user data. This may avoid interference between uplink shared channel (UL-SCH) transmissions and initial UL transmission attempts by different WTRUs. An initial uplink transmission preamble may (e.g., alternatively) use a short preamble format (e.g., configuration), which may have the same numerology (e.g., subcarrier spacing) as the data channel. An initial uplink transmission preamble may (e.g., therefore) be orthogonal to user data, for example, when they are scheduled in the same time-frequency resources. Initial UL transmission opportunities may be spread out in the time domain, for example, to minimize the average waiting time before an initial uplink transmission attempt may be initialized. Frequency domain multiplexing may (e.g., also) be used. The number of initial UL transmission regions may be configurable, for example, via a broadcast channel (e.g., NR-PBCH and/or secondary NR-PBCH). A configuration may be, for example, one initial UL transmission attempts per Y ms, or Z initial UL transmission attempts per 10 ms.

Initial UL transmission regions may be configured to be different from random access regions. Collisions may not occur between initial UL transmission attempts and random access attempts.

The transmission power of an initial UL transmission preamble may be set based on a pathloss estimate. The pathloss estimate may be obtained from measuring one or more of a cell-specific reference signals (CRS), an NR-PBCH-specific demodulation reference signal (DMRS) and/or beam-specific reference signals (BRS). Measurements may be made on a primary DL component carrier. An initial PIUCH transmission power may be obtained (e.g., from a pathloss estimate), for example, by adding a configurable offset.

Initial UL transmission may use power ramping. For example, the actual PIUCH transmission power may be increased, e.g., for each unsuccessful initial UL transmission attempt. In examples, PIUCH transmission power may be set to an initial PIUCH power for a first attempt. An initial UL transmission failure may be detected during a DL response channel that responds to initial UL transmission. PIUCH transmission power for the next attempt may be increased (e.g., by a configurable step size), for example, to increase the likelihood of the next initial UL transmission attempt being successful. Power ramping to control intra-cell interference may be needed less often for an initial UL transmission that is orthogonal to user data compared to a system with non-orthogonal initial UL transmission. Latency may be critical for some use cases (e.g., URLLC in NR). Transmission power for initial UL transmission may be set high enough for a first initial UL transmission to have a high likelihood of success. Power ramping may not be needed to minimize latency or delay.

Time-frequency resource and resource mapping/multiplexing may be implemented. A common resource, e.g., a resource shared with PRACH message 1, may be used. A reserved resource, e.g., a resource not shared with PRACH message 1, may be (e.g., exclusively) reserved for initial UL transmission. Dedicated, beam-specific or WTRU-specific transmission or reception may be implemented alone or in combination with these and other examples.

Implementation(s) for initial UL transmission may be provided. One or more of the following may apply.

A PIUCH transmission occasion may include a time-frequency resource. A PIUCH sequence or preamble may be transmitted using a configured PIUCH sequence or preamble format, e.g., on the time-frequency resource, with a Tx beam at WTRU.

An initial UL transmission (e.g., a single initial UL transmission) may be used. The initial UL transmission may be before the end of a monitored window that may be predetermined or configured. Multiple initial UL transmissions may be enabled. The initial UL transmissions may be until the end of a predetermined or configured window. An initial UL (e.g., sequence or preamble) transmission may be conducted. The initial UL (e.g., sequence or preamble) transmission may be after previous initial UL transmission procedure may not be completed. The initial UL (e.g., sequence or preamble) transmission may occur if a WTRU may not successfully receive DL response until the expiration of a predetermined or configured window and/or the WTRU fails during initial UL transmission procedure.

Initial UL (e.g., sequence or preamble) retransmissions may not be enabled, or the number of initial UL (e.g., sequence or preamble) retransmissions may be configured. There may be no initial UL (e.g., sequence or preamble) retransmissions allowed. The number of initial UL (e.g., sequence or preamble) retransmissions may be constrained by the maximum number of initial UL sequence and/or preamble transmissions configured by the network. A WTRU may send multiple initial UL transmissions before waiting to receive a DL response. An initial UL sequence (e.g., configuration), preamble retransmission, and/or power ramping may be used for multi-beam operation. A WTRU may perform beam switching. One or more of the following may be used or configured to be used: the counter of power ramping may be reset, the counter of power ramping may remain the same or unchanged, and/or the counter of power ramping may keep increasing.

A WTRU may not change or switch the beam. The counter of power ramping may keep increasing. A WTRU may derive the initial uplink or PIUCH transmission power using an estimate of pathloss and/or the like. A power ramping step size for initial UL transmission or PIUCH may be used. A WTRU may perform UL beam switching during the PIUCH retransmissions. A WTRU may switch to a better beam (e.g., the best beam) based on beam management and/or beam recovery for initial UL transmission.

NR-PBCH may configure information that may be used to receive a response to an initial UL transmission.

A network may transmit a message or a DL Response Channel, for example, in response to the detected initial UL transmission attempt. In an example, the message may contain one or more of the following: (i) minimum system information or scheduling information for minimum system information; (ii) an index of initial UL transmission preamble sequences a network may have detected and for which a DL Response Channel is valid; (iii) an index of orthogonal cover code (OCC) for initial UL transmission preamble sequences a network may have detected; (iv) a timing correction calculated by an initial UL transmission preamble receiver; (v) a scheduling grant that may indicate what resources a WTRU may use for transmission of a message in a (e.g., the next) UL transmission or later in a random access procedure; and/or (vi) a temporary identity TC-RNTI that may be used for further communication between a network and a WTRU.

Individual response messages to multiple WTRUs may be combined in a single transmission in a DL Response Channel, for example, when a network detects multiple initial UL transmission attempts from different WTRUs. A response message may be scheduled on an NR-DL-SCH and indicated on a NR-PDCCH, for example, using an identity reserved for an initial UL response (IUR) transmission or DL Response Channel, e.g., IUR-RNTI. IUR-RNTI may be utilized, for example, given that a WTRU may not have a unique identity (e.g., in the form of C-RNTI) allocated at this stage. WTRUs that may have transmitted an initial UL transmission preamble may monitor NR-PDCCH control channels for initial UL transmission responses within a configurable time window. The timing of a response message may not be fixed to respond to simultaneous initial UL transmissions. A WTRU may not detect an initial UL transmission response within a time window. An initial UL transmission may be declared failed and the procedure may repeat (e.g., from the beginning), possibly with an increased preamble transmission power.

A collision may not occur, for example, when WTRUs that perform initial UL transmission in the same resource use different preambles relative to the preambles that other WTRUs use to perform random access. An initial UL transmission response message may make it clear to which WTRU information may be related, e.g., by preamble index. Multiple WTRUs may react upon the same DL response message and a collision may occur, for example, when WTRUs that perform initial UL transmission in the same resource use the same preambles relative to those used by other WTRUs to perform random access.

Contention-free initial UL transmission using a dedicated preamble or exclusively reserved preamble(s) using PIUCH set may be used. There may be no need to handle contention between initial UL transmission and random access, for example, when preambles used for initial UL transmission and contention-based random access in the same resource may be (e.g., are) different. A WTRU may have a unique identity allocated to it, e.g., in the form of a C-RNTI.

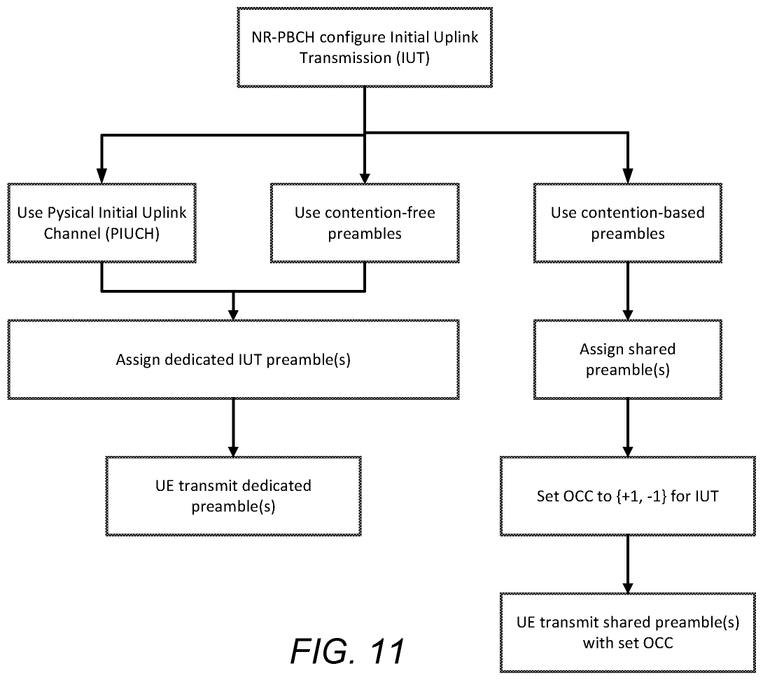

FIG. 11 is an example associated with configuring an initial uplink transmission preamble. NR-PBCH may configure initial uplink transmission. NR-PBCH may configure for initial uplink transmission, for example, physical initial uplink channel (PIUCH), contention-free preambles and/or contention-based preambles. A dedicated preamble may be assigned for initial uplink transmission, for example, when using physical initial uplink channel (PIUCH) or contention-free preambles. A WTRU may transmit a dedicated preamble in the configured time-frequency resources for initial uplink transmission. NR-PBCH may (e.g., alternatively) configure contention-based preambles for initial uplink transmission. A shared preamble (e.g., a sequence or configuration shared by one or more WTRUs) may be (e.g., randomly) assigned for initial uplink transmission. A WTRU may transmit a shared preamble (e.g., sequence or configuration) in a configured time-frequency resources for initial uplink transmission. A network may (e.g., to distinguish initial uplink transmission and random access) assign orthogonal cover code (OCC) to one or more values corresponding to initial uplink transmission, e.g., in addition to preamble (e.g., sequence or configuration). For example, OCC may be set to {+1 −1}, e.g., to represent initial uplink transmission. A WTRU may transmit a preamble with an OCC. An OCC may be set, for example, depending on implementation, to {+1 −1 +1 −1} to represent initial uplink transmission. A Hadamard code or matrix may be used for OCC generation of different lengths.

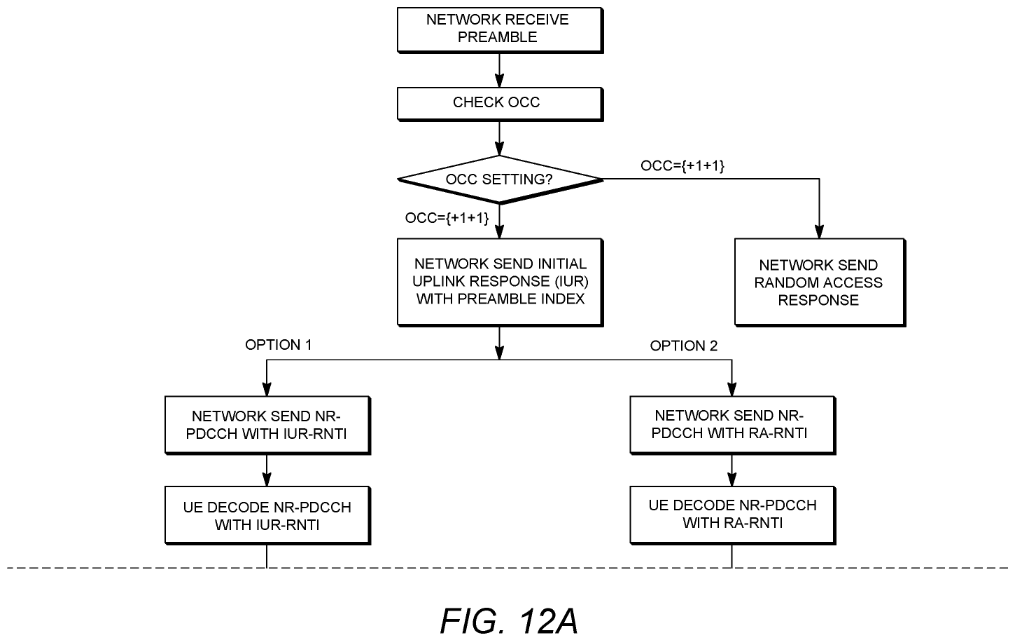

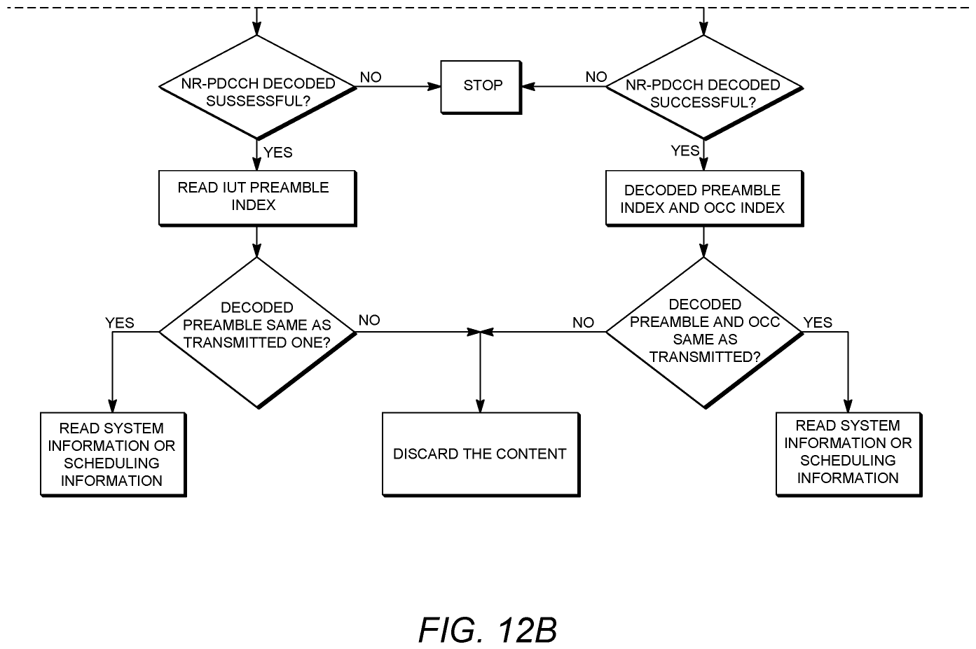

FIGS. 12A and 12B are an example of an initial uplink response. A network may receive preambles that are transmitted by WTRUs. A network may check OCC settings within the received preambles. A network may send an initial uplink response back to WTRUs, for example, when an OCC setting indicates an initial uplink transmission. A network may send a random access response back to WTRUs, for example, when an OCC setting indicates random access. A network may send an initial uplink response (e.g., comprising a preamble index and/or an OCC index), for example, for an initial uplink response. One or more of the following may be used to perform initial uplink response.

In examples, a network may send NR-PDCCH masked with IUR-RNTI. A WTRU may decode NR-PDCCH with IUR-RNTI. A WTRU may read (e.g., receive) a preamble index in initial uplink response, for example, when a NR-PDCCH is decoded successfully. A WTRU may compare a preamble index in a received initial uplink response with a preamble index that is originally transmitted. A WTRU may (e.g., when they are the same) read system information, scheduling information and/or other information carried in an initial uplink response. A WTRU may (e.g., otherwise) discard the content in an initial uplink response.

In examples, a network may send NR-PDCCH masked with a random access (RA)-RNTI for an initial uplink response. A WTRU may decode NR-PDCCH with RA-RNTI. A WTRU may read (e.g., receive) a preamble index and OCC index in initial uplink response, for example, when an NR-PDCCH is decoded successfully. A WTRU may compare a preamble index and OCC index in a received initial uplink response with a preamble index and OCC index that may have been originally transmitted. A WTRU may (e.g., when they are the same) read system information, scheduling information or other information carried in an initial uplink response. A WTRU may (e.g., otherwise) discard the content in an initial uplink response.

NR-PBCH may configure a DL Response Channel, e.g., information necessary to receive a response to an initial UL transmission. An exclusive DL response channel (e.g., unlike NR-PRACH message 2) may be used. An NR-PRACH message 2 or similar may be used.

An initial uplink transmission may be based on, for example, an NR-PRACH sequence. An NR-PRACH sequence may be determined.

In examples, a basic unit, which may comprise a cyclic prefix (CP), sequence (one or multiple), and a guard time (GT), may be generated. In examples, a GT may be set to zero, e.g., there may be no GT. In examples, the GT may be set to different values. The GT values may be large or small. A sequence may be, for example, a Zadoff-Chu sequence, Zadoff-Chu sequence multiplied with m sequence (e.g., element-by-element multiplication), PN sequence, m sequence, Golay sequence, gold sequence, unique word (UW) and/or the like. The basic unit may be repeated in the time domain. An orthogonal cover code (0CC) may be applied on the sequence.

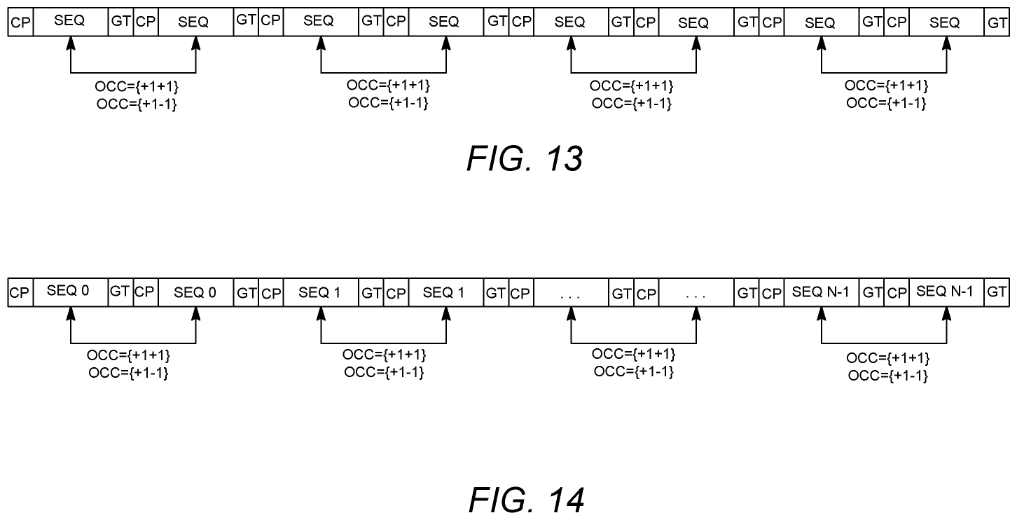

FIG. 13 is an example of an initial uplink transmission sequence. FIG. 13 shows an example with the same basic unit (e.g., sequence) with an OCC repeating in the time domain.

FIG. 14 is an example of an initial uplink transmission sequence. FIG. 14 shows an example with different basic units (e.g., Seq 0 to Seq N-1) with OCC repeating in the time domain.

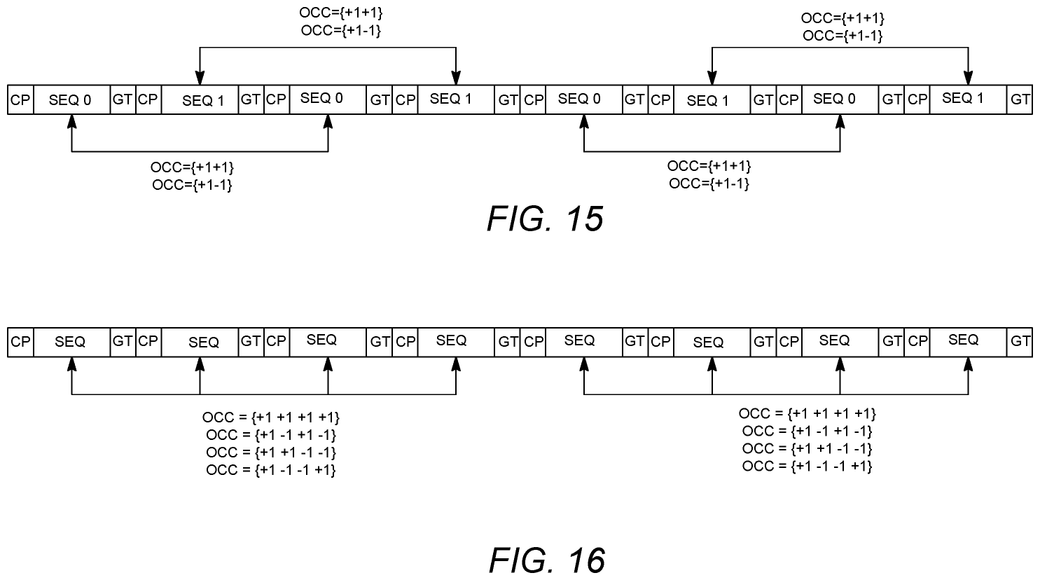

FIG. 15 is an example of an initial uplink transmission sequence. FIG. 15 shows an example with the same basic unit repeating alternately in the time domain. OCC may be applied on the alternately repeated sequence in the time domain.

FIG. 16 is an example of an initial uplink transmission sequence. FIG. 16 shows an example with the same basic unit (e.g., sequence or Seq) with longer OCC repeating in the time domain.

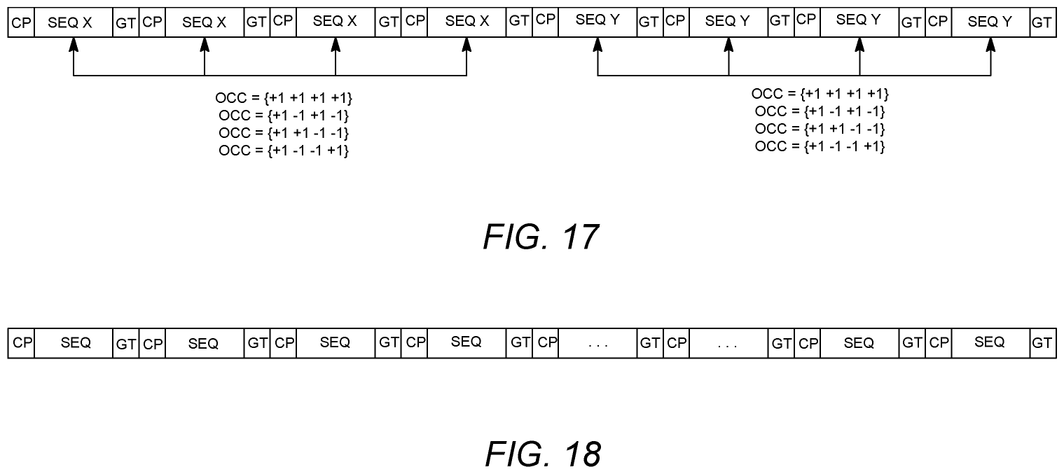

FIG. 17 is an example of an initial uplink transmission sequence. FIG. 17 shows an example with different basic units (e.g., Seq x and Seq y) with longer OCC repeating in the time domain.

FIG. 18 is an example of an initial uplink transmission sequence. FIG. 18 shows an example with the same basic unit repeating in the time domain. OCC may not be applied to a basic unit (e.g., in this case).

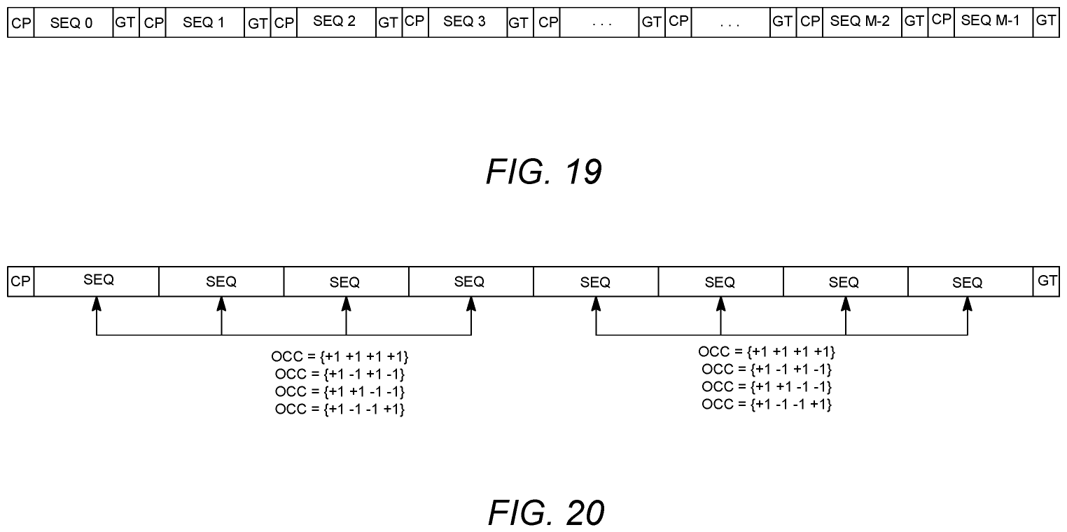

FIG. 19 is an example of an initial uplink transmission sequence. FIG. 19 shows an example with a different basic unit not repeating in the time domain. OCC may not be applied to a basic unit (e.g., in this case).

A CP and/or GT in the middle part of a constructed sequence may be omitted. The first CP and last GT may be preserved. FIG. 20 shows an example with CP and GT omitted in the middle part of a constructed sequence. OCC may be applied (e.g., in this case).

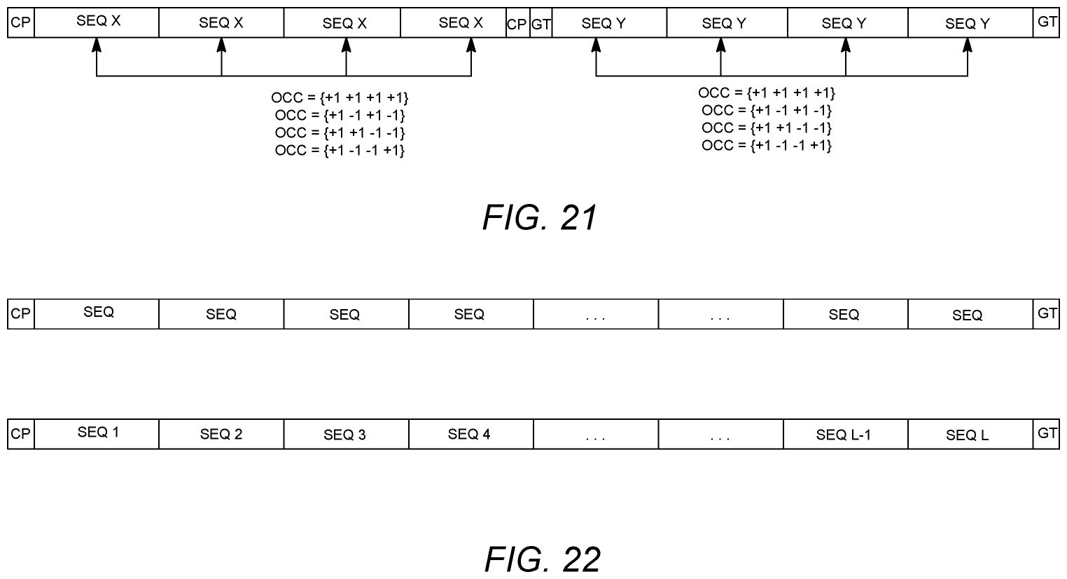

Some (e.g., most) of CP and/or GT may be removed. The first CP, last GT and CP/GT (e.g., in the middle part of a constructed sequence) may be preserved. OCC may be applied. FIG. 21 shows an example with CP and GT omitted in the middle part of a constructed sequence except CP/GT between two sets of OCCs. Sequence x and sequence y may be the same or different. In an example, x may equal to y when seq x and seq y are the same, and, x may not be equal to y when seq x and seq y are not the same.

FIG. 22 is an example of an initial uplink transmission sequence (e.g., OFDM symbol). FIG. 22 may show a design for multiple initial UL sequence, multiple preamble transmissions, repeated initial UL sequence, and/or repeated preamble transmissions. CP may be inserted at the beginning of the multiple OFDM symbols or PIUCH OFDM symbols (e.g., consecutive multiple OFDM symbols or PIUCH OFDM symbols). CP may be inserted at the beginning of the repeated OFDM symbols or PIUCH OFDM symbols (e.g., the consecutive repeated OFDM symbols or PIUCH OFDM symbols). CP between OFDM symbols or PIUCH OFDM symbols may not be used. GT between OFDM symbols or PIUCH OFDM symbols may not be used. GT may be used at the end of the multiple OFDM symbols or PIUCH OFDM symbols (e.g., the consecutive multiple OFDM symbols or PIUCH OFDM symbols). GT may be used at the end of the repeated OFDM symbols or PIUCH OFDM symbols (e.g., the consecutive repeated OFDM symbols or PIUCH OFDM symbols).

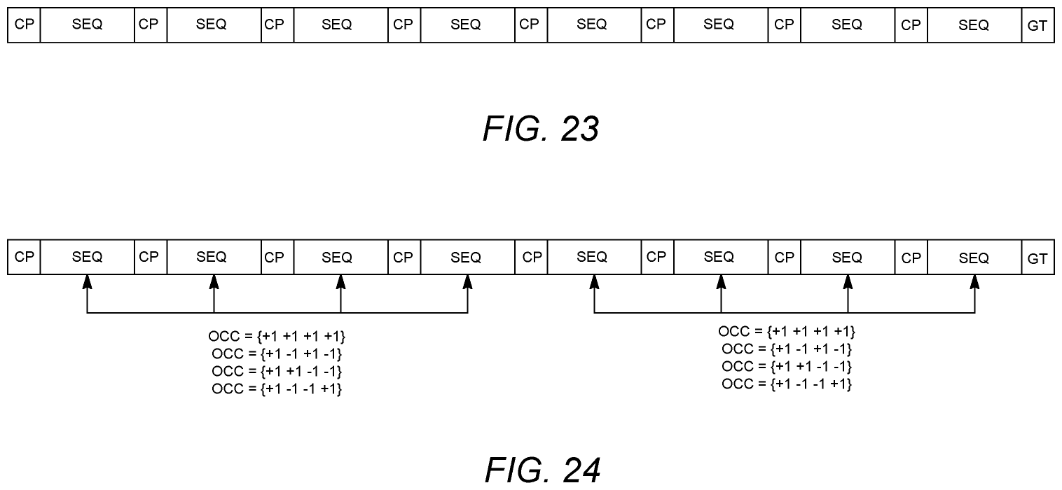

FIG. 23 is an example of an initial uplink transmission sequence. FIG. 23 may show a design for multiple initial UL sequences, multiple PIUCH sequence, multiple preamble transmissions, repeated initial UL sequences, repeated PIUCH sequence, and/or repeated preamble transmissions. CP may be inserted at the beginning of the multiple PIUCH OFDM symbols (e.g., consecutive multiple PIUCH OFDM symbols). CP may be inserted at the beginning of the repeated PIUCH OFDM symbols (e.g., consecutive repeated PIUCH OFDM symbols). CP between PIUCH symbols may be inserted. GT between PIUCH symbols may not be inserted. GT may be used at the end of the multiple PIUCH symbols (e.g., the consecutive multiple PIUCH symbols). GT may be used at the end of the repeated PIUCH symbols (e.g., the consecutive repeated PIUCH symbols). FIG. 24 is an example of an initial uplink transmission sequence. FIG. 24 may show a design for multiple and/or repeated PIUCH sequence or preamble transmissions similar to FIG. 23. OCC may be used as shown in FIG. 24.

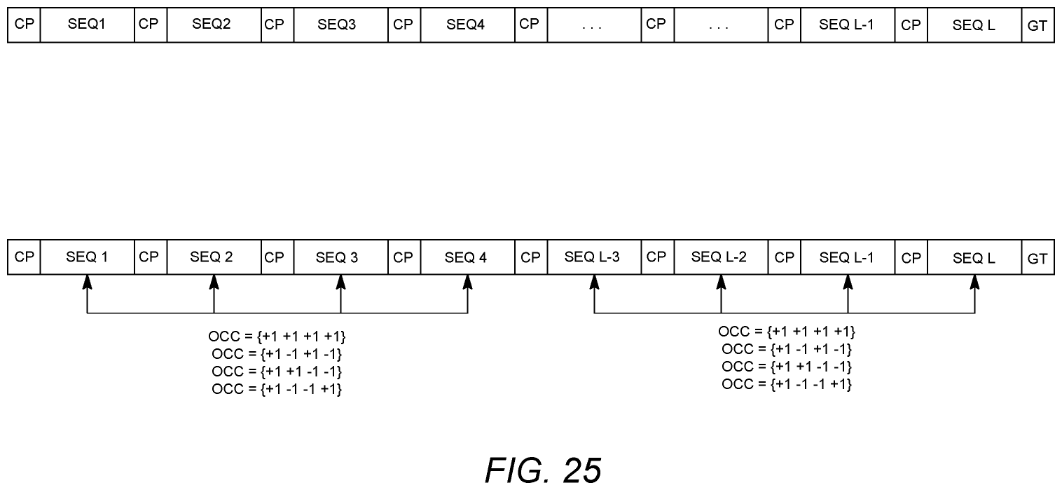

FIG. 25 is an example of an initial uplink transmission sequence. FIG. 25 may show a design for multiple and/or repeated PIUCH sequence or preamble transmissions. The design shown in FIG. 25 may be similar to the design shown in FIG. 23 and/or FIG. 24. Different sequences or preambles may be used as shown in FIG. 25. Sequence or preamble hopping may be used in the design shown in FIG. 25. Different combinations of sequences or preambles may be utilized.

Flexibility in the length of CP and/or GT may be supported. Flexibility in the number of PIUCH sequence or preambles and/or PIUCH symbols (e.g., repeated PIUCH sequence or preambles and/or PIUCH symbols) may be supported. For example, flexibility in the length of CP and/or GT and the number of repeated PIUCH sequence or preambles and PIUCH symbols may be supported to enable various coverage and/or forward compatibility. Use of the sequence designs may depend on PIUCH subcarrier spacing and/or TRP beam correspondence or reciprocity. A PIUCH sequence or preamble format may include one or multiple PIUCH sequence(s) or preamble(s). A PIUCH sequence or preamble may include one or more sequence or preamble sequence plus CP(s). A sequence or preamble sequence may include one or multiple PIUCH OFDM symbol(s). WTRU may transmit PIUCH according to the configured initial UL transmission or PIUCH sequence format or preamble format.

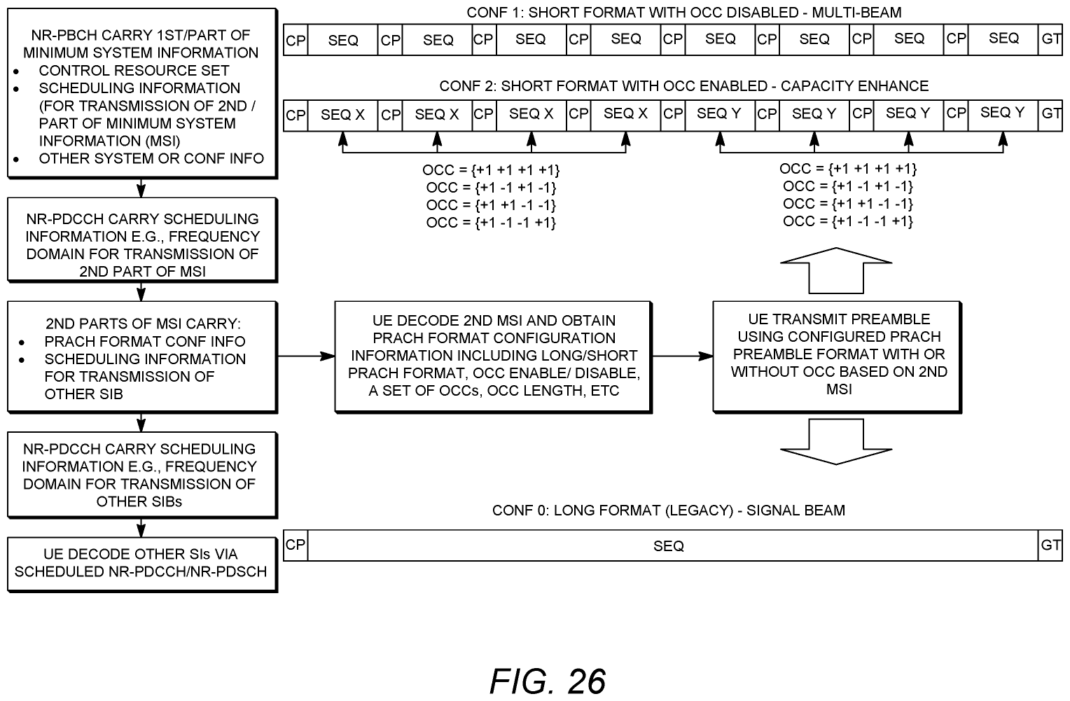

PRACH or initial UL transmission enabling approaches may be provided. FIG. 26 may illustrate an example of system information delivery, e.g., to enable initial UL transmission or PRACH transmission. One or more (e.g., three) configurations may be associated with one or more (e.g., three) PRACH formats. The configurations may include configuration 0 (e.g., long format such as legacy). Configuration 0 may be used for single beam case. The configurations may include configuration 1 (e.g., short format with OCC disabled). Configuration 1 may be used for multi-beam case. The configurations may include configuration 2 (e.g., short format with OCC enabled). Configuration 2 may be used for multi-beam case. Configuration 2 may be used for capacity enhancement. NR-PBCH may carry a first part of minimum system information (MSI) including one or more of control resource set(s), scheduling information (e.g., for transmission of a second part of MSI), or other system or configuration information. Layer 1 control signaling such as NR-PDCCH may carry scheduling information, e.g., frequency domain scheduling information for transmission of a second part of MSI. The second part of MSI may carry one or more of PRACH format configuration information, schedule information for transmission of other SIB(s), or the like.

A WTRU may decode the second MSI and/or obtain PRACH format configuration information e.g., configurations 0, 1 or 2 as depicted in FIG. 26. The configuration information may include one or more of long/short PRACH format, OCC enable/disable, a set of OCCs, OCC length, or the like. A WTRU may transmit preamble (e.g., accordingly) using received configured PRACH preamble format based on the received, second MSI. The configured PRACH format may include PRACH preamble format with or without OCC.

NR-PDCCH may carry scheduling information, for example, frequency domain resource allocation for transmission of other SIB(s). A WTRU may decode other SIs via the scheduled NR-PDCCH/NR-PDSCH.

Autonomous WTRU PRACH format transmission may be used. A WTRU may select (e.g., autonomously) the PRACH format based on the measurement at the WTRU. The measurement may include WTRU speed. When a measured WTRU speed is high, the WTRU may select PRACH format without OCC or OCC disabled. When a measured WTRU speed is low, the WTRU may select PRACH format with OCC or OCC enabled. When OCC is enabled, the WTRU may select PRACH format with different lengths of OCC, for example, based on different ranges of WTRU speed. For example, a shorter 0CC length may be selected and/or used for higher WTRU speed. Longer OCC length may be selected and/or used for lower WTRU speed. The approaches/implementations described herein may be applied to the network configured PRACH format approach or WTRU selected PRACH format approach. For the network configured PRACH format approach, gNB or TRP may configure the PRACH format that the WTRU uses for transmitting PRACH preamble. gNB or TRP may deliver configuration information to the WTRU (e.g., via system information such as the second part of MSI or NR-PBCH as described herein). For WTRU selected PRACH format approach, a WTRU speed may be measured or known at TRP or gNB. TRP or gNB may perform blind PRACH format detection to obtain the information for PRACH format that the WTRU selects.

Subcarrier-spacing-based initial uplink or PRACH transmission may be provided. A system may be designed to have multiple (e.g., two or more) subcarrier spacings or numerologies for initial uplink signal or PRACH signal. For example, the subcarrier spacing may be denoted as Sᵢ, i=1,2, . . . , K. The network may configure the subcarrier spacing for initial uplink or PRACH transmission. The subcarrier spacing configuration may be indicated in MSI. For example, the second part of MSI may be used to carry the configuration information for subcarrier spacing. The network may configure different subcarrier spacing for PRACH transmission or initial uplink transmission. For example, the network may configure different subcarrier spacing based on one or more of whether a single beam or multi-beam is used, beam sweeping latency, service types, or the like. Different subcarrier spacing may be used for a single beam operation or a multi-beam operation, or different number of beams. Small subcarrier spacing may be used for a single beam operation. Large subcarrier spacing may be used for a multi-beam operation. Subcarrier spacing may be based on the number of beams K. For example, if the number of beams is larger, a larger subcarrier spacing may be used. If the number of beams is smaller, a smaller subcarrier spacing may be used. The network may configure different subcarrier spacing based on beam sweeping latency. For example, large subcarrier spacing may be used for low latency beam sweeping or low latency application. Small subcarrier spacing may be used for higher latency beam sweeping or application. The network may configure different subcarrier spacings based on service types including delay-sensitive services and/or URLLC or non-URLLC.

Numerology may be subcarrier spacing and/or cyclic prefix (CP). The network may signal numerologies or subcarrier spacings for PRACH preamble transmission or initial uplink transmission, e.g., using one or more of the following. MSI may be used to signal subcarrier spacing for PRACH preamble or initial uplink transmission. The second part of MSI may be used to indicate subcarrier spacing for PRACH preamble or initial uplink transmission. NR-PBCH may be used to signal subcarrier spacing for PRACH preamble or initial uplink transmission.

The network may signal numerology or subcarrier spacing information for random access response (RAR) and/or PRACH message 3 and 4. A subcarrier spacing indicator (e.g., indicator of one or more bits) may be used to indicate subcarrier spacing Sᵢ, Sⱼ, Sₖ for RAR, PRACH message 3, and PRACH message 4 respectively. The subcarrier spacing indicator (e.g., one or more bit subcarrier spacing indicator) may be carried in NR-PBCH and/or the second part of MSI. For example, the subcarrier spacing indicator may be carried in NR-PBCH to indicate the subcarrier spacing or numerology for the second part of MSI (e.g., RMSI). The same subcarrier spacing or numerology for the second part of MSI (e.g., RMSI) may be used for subcarrier spacing or numerology for RAR, RACH message 2, or RACH message 4. RAR may be used to indicate subcarrier spacing information for PRACH message 3 and 4. NR-PBCH may be used to indicate subcarrier spacing or numerology for the second part of MSI (e.g., RMSI) which may be used to indicate subcarrier spacing Sᵢ, Sⱼ, Sₖ for RAR, or PRACH message 3, and PRACH message 4 respectively. PRACH message 4 may be used to indicate subcarrier spacing Sₘ for data channel (e.g., NR-PDSCH) and Sₙ for control channel (e.g., NR-PDCCH). MSI may be used to carry subcarrier spacing or numerology information for paging channel or paging signaling such as paging DCI. NR-PBCH or the second part of MSI may be used to indicate subcarrier spacing information for paging channel or paging signaling such as paging DCI. For example, NR-PBCH may be used to carry the indication of subcarrier spacing or numerology for the second part of MSI (e.g., RMSI). The same subcarrier spacing or numerology for the second part of MSI (e.g., RMSI) indicated in NR-PBCH may be used for subcarrier spacing or numerology for paging channels (e.g., CORESET, paging DCI, paging message) and/or other system information (OSI) (e.g., CORESET, PDCCH, PDSCH for OSI).

The network may indicate the waveform associated with the indicated subcarrier spacing to a WTRU. The waveform associated with the indicated subcarrier spacing may include cyclic prefix (CP)-OFDM, discrete Fourier transform (DFT)-spread(S)-OFDM or unique word based OFDM or DFT-s-OFDM. The network may indicate the waveform to a WTRU for transmission of PRACH preamble, RACH message 3 or uplink control channel. For example, RAR, RMSI, or OSI may be used to indicate the waveform used for RACH message 3 transmission associated with an indicated subcarrier spacing. RMSI or OSI may be used to indicate the waveform used for PRACH preamble transmission associated with an indicated subcarrier spacing.

Method to determine subcarrier spacing of 2^{nd} part of minimum system information and/or RMSI may be provided. One or more of the following may apply.

Subcarrier spacing of the 2^{nd} part of minimum system information and/or RMSI may be indicated by an indicator (e.g., carried by NR-PBCH). Such indicator may be N-bit (e.g., depending on the number of subcarrier spacing). For example, to support up to 2 subcarrier spacings, a N=1 bit indicator in PBCH may be used. To support up to 4 subcarrier spacings, a N=2 bits indicator in PBCH may be used. Subcarrier spacing of the PRACH preamble, RACH message 1, or RACH message 3 may be indicated by an indicator (e.g., carried by RMSI). Such indicator may be an indicator of N-bits (e.g., depending on the number of subcarrier spacing). For example, to support up to 2 subcarrier spacings, a N=1 bit indicator in RMSI or OSI may be used. To support up to 4 subcarrier spacings, a N=2 bits indicator in RMSI or OSI may be used.

Subcarrier spacing of the 2^{nd} part of minimum system information and/or RMSI may be indicated by NR-PBCH DMRS. Such indication may be performed via N-hypotheses (e.g., depending on number of subcarrier spacing). For example, to support up to 2 subcarrier spacings, two hypotheses generated by PBCH DMRS may be used. To support up to 4 subcarrier spacings, four hypotheses generated by PBCH DMRS may be used.

A subcarrier spacing of the 2^{nd} part of minimum system information or RMSI may be indicated by a NR-PBCH subcarrier spacing(s). Such indication may be predefined. For example, the subcarrier spacing of the 2^{nd} part of minimum system information or RMSI may be the same as a NR-PBCH subcarrier spacing(s). A predefined rule to determine the subcarrier spacing of the 2^{nd} part of minimum system information or RMSI (e.g., based on an NR-PBCH subcarrier spacing(s)) may be used. An association (e.g., a fixed association) between the NR-PBCH subcarrier spacing and the subcarrier spacing of the 2^{nd} part of minimum system information or RMSI may be applied. Similarly, the subcarrier spacing of paging channels (e.g., paging message, paging DCI, paging CORESET, paging search space) may be indicated by the 2^{nd} part of MSI or RMSI, or may be the same as the subcarrier spacing(s) of 2^{nd} part of MSI or RMSI. Subcarrier spacing of RACH message 2 and message 4 may be indicated by the 2^{nd} part MSI or RMSI, or may be the same as the subcarrier spacing(s) of 2^{nd} part of MSI or RMSI. Subcarrier spacing of OSI may be indicated by the 2^{nd} part of MSI or RMSI, or may be the same as the subcarrier spacing(s) of 2^{nd} part of MSI or RMSI.

OCC may be configured to enable a beam recovery and/or support system information on demand delivery. In case that OCC is configured to enable beam recovery, OCC may be used as a beam recovery request signal sent from a WTRU (e.g., UE) to gNB or TRP. For example, when a WTRU performs (e.g., needs to perform) beam recovery, the WTRU may initiate a beam recovery procedure by sending the beam recovery request signal to gNB or TRP. The gNB or TRP may start the beam recovery procedure (e.g., accordingly) upon receiving the beam recovery request signal (e.g., in the form of OCC). In case that OCC may be configured to support system information on demand delivery, OCC may be used as a request signal for system information delivery. Such request signal (e.g., in the form of OCC) may be sent from the WTRU to the gNB or TRP to request system information delivery on demand. The gNB or TRP may start the system information on demand procedure (e.g., accordingly) upon receiving the system information on demand request signal.

Different PRACH preamble formats may be combined. One PRACH preamble format with a CP but without a GT may be combined with another PRACH preamble format with a CP and a GT. For example, PRACH preamble format with a CP but without a GT may be placed in front of another PRACH preamble format with a CP and a GT within a slot, mini-slot, or non-slot. PRACH preamble format with a CP and a GT may be placed in the last RACH resource or RACH occasion within a slot, mini-slot, or non-slot. PRACH preamble format with a CP and a GT may be placed in the end of a slot, mini-slot, or non-slot.

NR-PBCH may be used to assist with Cell ID detection and/or final physical cell ID identification (e.g., in NR). In an example, NR-PBCH and NR-SSS may be used to detect a physical cell ID, e.g., as opposed to detecting a physical Cell ID by PSS and SSS signals where, for example, a PSS may detect symbol timing, synchronize with the symbol timing and detect Cell ID (e.g., 3) and an SSS may detect frame timing synchronization and a Cell group ID (e.g., 168).

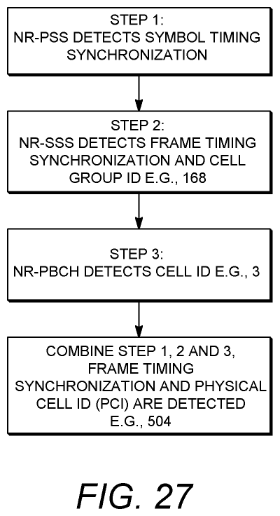

FIG. 27 is an example of a cell ID detection procedure. NR-PBCH and NR-SSS may be used to detect a physical cell ID. An example implementation may include one or more of the following. NR-PSS may detect symbol timing and synchronize with the symbol timing. NR-SSS may detect frame timing synchronization and Cell group ID (e.g., 168). NR-PBCH may detect Cell ID (e.g., 3).

A physical cell identity (PCI), Npa, may be defined by Eq. 1:

N_{PCI}=3N_{GID}+N_{CID} Eq. 1

N_{GID} may be a physical layer cell identity group (e.g., 0 to 167) acquired by NR-SSS. N_{CID} may be an identity within the group (e.g., 0 to 2) acquired by NR-PBCH. This arrangement may create, for example, 504 unique physical cell identities that may be detected by a procedure using NR-SSS and NR-PBCH. NR-SSS and NR-PBCH locations (e.g., with respect to NR-PSS in time and frequency) may be known to the WTRU, for example, when a WTRU finds the NR-PSS. A WTRU may detect NR-SSS and decode NR-PBCH. A WTRU may acquire the final physical cell ID (PCI).

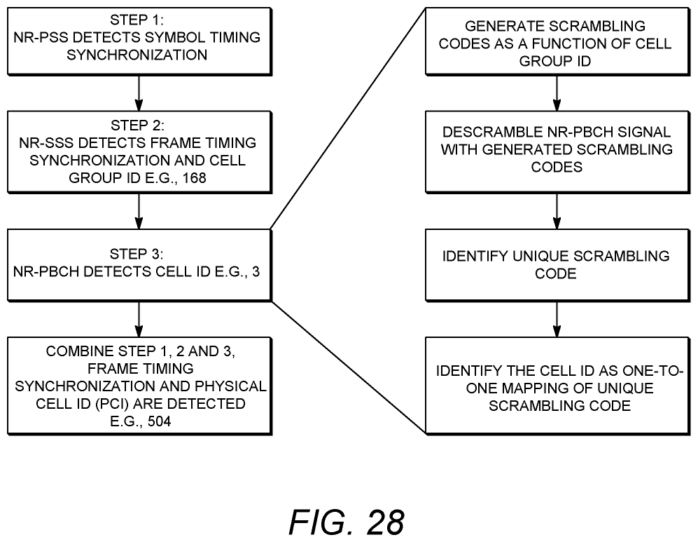

FIG. 28 is an example of a Cell ID detection. FIG. 28 may show an example of details for the implementation shown in FIG. 27 to acquire physical cell ID (PCI). For example, NR-PSS may detect symbol timing and synchronize with the symbol timing. NR-SSS may detect frame timing synchronization and Cell group ID. NR-PBCH may detect Cell ID.

A WTRU procedure for detecting cell ID may generate scrambling codes or sequences, for example, as function of the cell group ID. A WTRU may descramble an NR-PBCH signal, for example, using generated scrambling codes and/or sequences. A WTRU may identify one or more unique scrambling codes and/or sequences among multiple scrambling codes or sequences, for example, using a peak detection algorithm and/or by decoding the NR-PBCH payload. A scrambling code or sequence may represent a cell ID (e.g., using a one-to-one mapping procedure), for example, when an NR-PBCH is decoded successfully using a scrambling code or sequence.

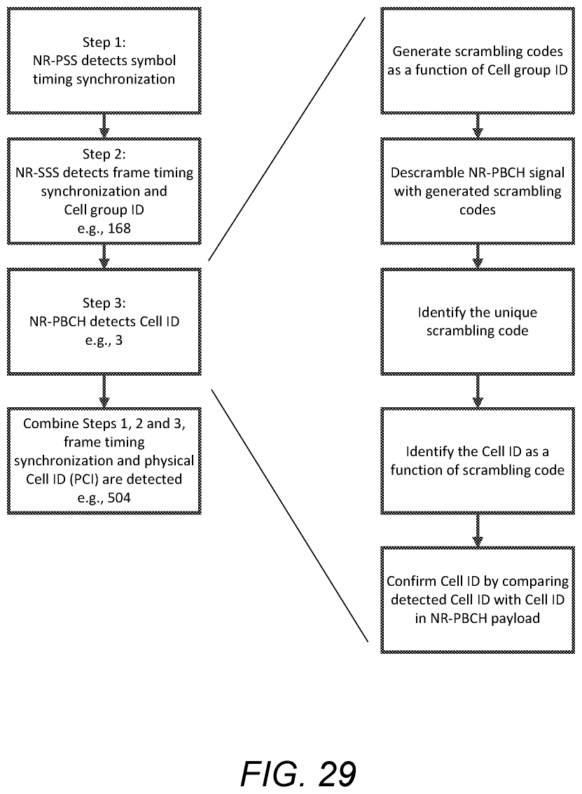

FIG. 29 is an example of a cell ID detection with confirmation. A cell ID may be (e.g., further) confirmed, for example, by decoding an NR-PBCH channel and reading the content of an NR-PBCH payload. A cell ID may be encoded over an NR-PBCH payload. An NR-PBCH payload may be read, e.g., using a scrambling code or sequence. A detected cell ID may be confirmed, for example, by identifying a cell ID from reception of the NR-PBCH payload cover code or a similar procedure.

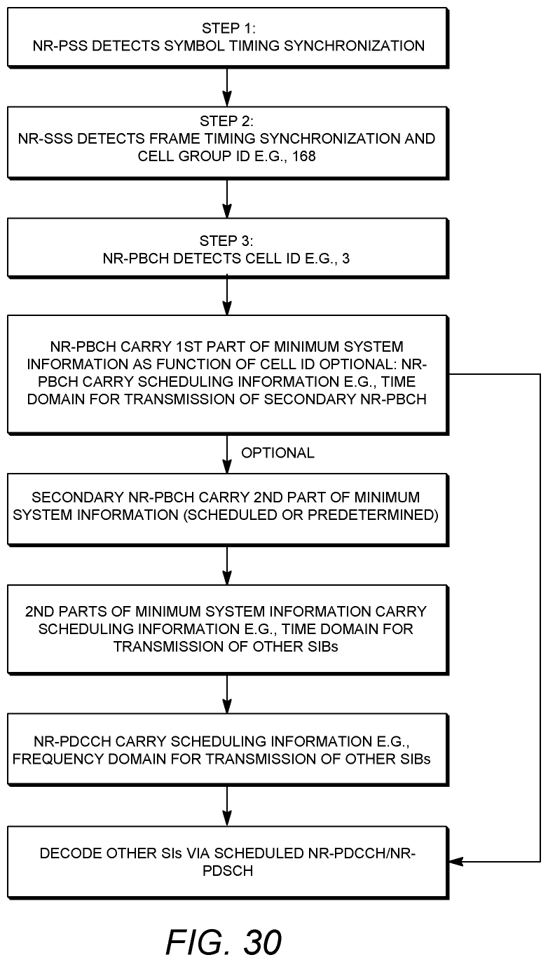

FIG. 30 is an example of a cell ID detection. A WTRU may obtain minimum system information (e.g., as function of PCI obtained by NR-PBCH and NR-SSS), for example, when a physical cell ID (PCI) is obtained.

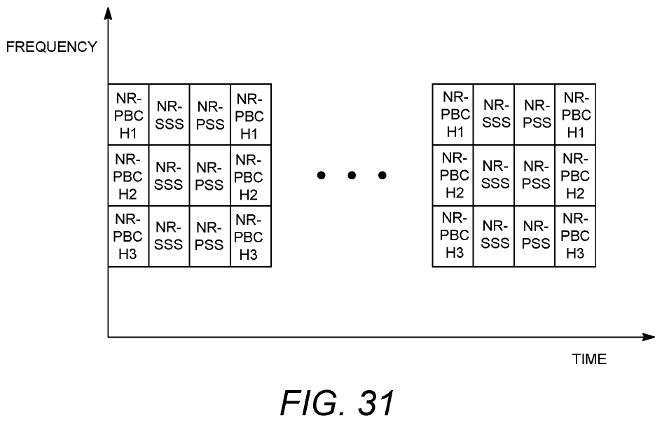

FIG. 31 is an example of a cell ID detection.

In an (e.g., alternative) example, an NR-PBCH may be designed to have multiple copies of an NR-SSS and/or NR-PSS in the frequency domain, e.g., as shown in FIG. 31. A frequency domain index may provide a cell ID (e.g., implicitly), for example, by decoding different copies. NR-SSS and NR-PBCH locations in time and frequency with respect to NR-PSS may be known to a WTRU, for example, when the WTRU finds NR-PSS. A WTRU may try to decode NR-PBCH 1, 2, 3, e.g., as shown in FIG. 31. A WTRU may decode NR-PBCH k. A frequency location may embed cell ID information. For example, frequency location k may correspond to cell ID # k or NR-PBCH # k may correspond cell ID # k. An NR-PBCH may be masked with different CRC masks using different generated sequences. A cell ID may be obtained, for example, by decoding and de-masking an NR-PBCH signal. For example, a CRC masked by sequence k may correspond to cell ID k.

NR-PSS and NR-SSS may be repeated in the frequency domain, for example, to increase the robustness of signal detection. NR-PBCH may (e.g., also) be repeated in the time domain, e.g., as shown in FIG. 31. Repeating NR-PSS and NR-SSS in the frequency domain may enhance detection performance. Repeating NR-PBCH in the time domain may enable a more accurate estimation of CFO.

Implementations may be provided to indicate SS-Block index and/or determine subframe timing, frame timing, or slot timing. An NR-PBCH may indicate an SS-block index. An SS-block index may be inserted in an NR-PBCH payload. An SS-block index may be read from the content of a payload in NR-PBCH, for example, when decoding an NR-PBCH signal and channel.

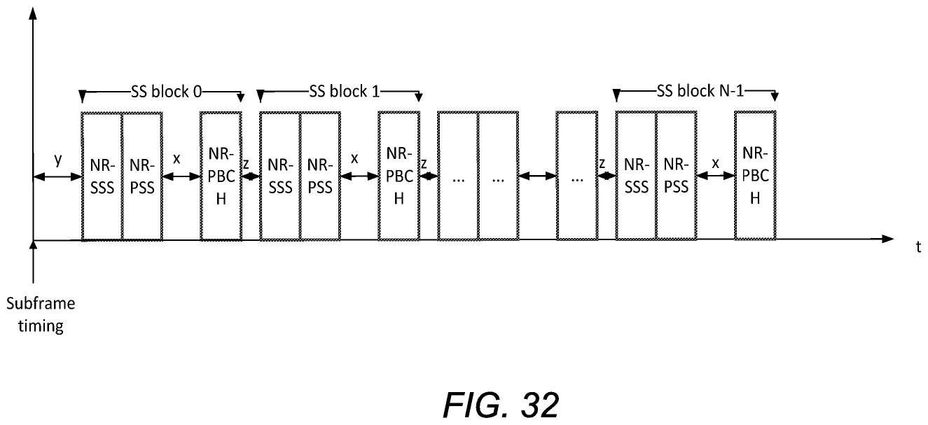

FIG. 32 is an example of an SS-Block and Subframe Timing. NR-SSS, NR-PSS and NR-PBCH may be multiplexed within an SS block. There may be more than one SS block, for example, to support multi-beam operation. There may be an offset y for NR-SSS, e.g., with respect to subframe timing. NR-PSS may occur (e.g., right) after NR-SSS. There may be an offset x for NR-PBCH, e.g., with respect to NR-PSS. There may be an offset z between adjacent SS blocks. An SS block may be identified and offsets may be applied, for example, to determine subframe timing.

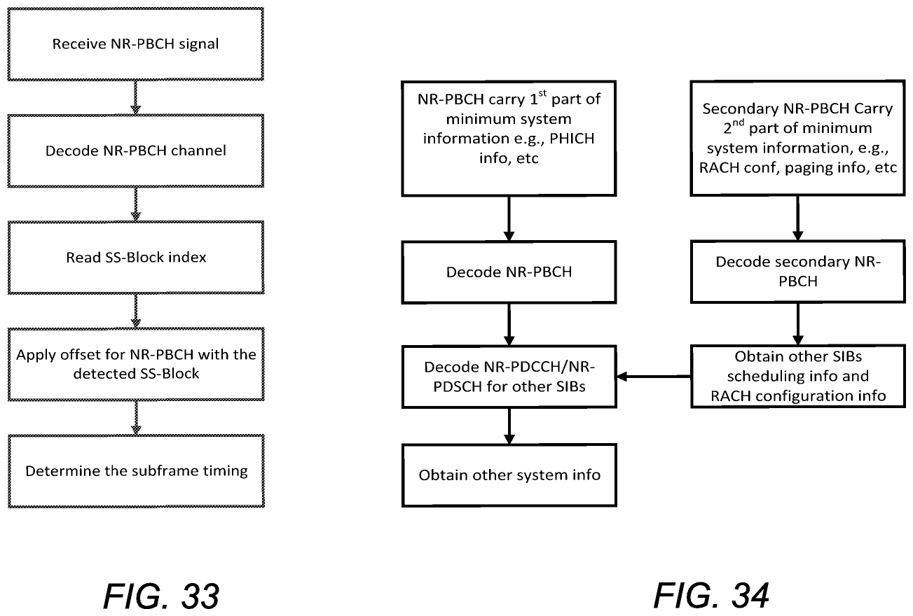

FIG. 33 is an example using an NR-PBCH to indicate an SS-Block Index and determine subframe timing. A WTRU may receive an NR-PBCH signal. A WTRU may decode an NR-PBCH channel. A WTRU may read an SS-Block index from an NR-PBCH payload. A WTRU may determine subframe timing or slot timing, for example, by applying relevant offsets, e.g., in addition to an SS block index.

Subframe timing, slot timing, and/or frame timing may be determined, for example, according to Eq. 2:

T_{subframe}=(Tₛₛ_{_{block}}+z)×Idxₛₛ_{_{block}}+2T_{sym} +x+y Eq. 2

T_{sym} may be a symbol duration. Tₛₛ_{_{block}} may be an SS block duration. Idxₛₛ_{_{block}} may be an SS-Block index. NR-PSS, NR-SSS or NR-PBCH may occupy one or more OFDM symbols.

An implicit implementation to indicate an SS-block index may be used.

An SS BlockID (e.g., in an explicit way) may be considered as a part of payload on an NR-PBCH. SS BlockID may be coded and/or rate-matched and/or interleaved along with other bits of NR-PBCH and/or transmitted on data REs. An explicit transmission may be associated with delay in decoding. The SS Block ID may not be found or identified till decoding of NR-PBCH (e.g., at the receiver). An implicit implementation(s) may be described herein.

An implicit SS block index indication(s) may be used. One or more of the following may apply.

For detecting (e.g., coherently) the NR-PBCH, a reference signal (e.g., a self-contained DMRS) may be used/added. The DMRS may be a known sequence to the receiver. Different sequences and/or shifts may be used to implicitly indicate the SS Block index. A receiver may detect which hypothesis of a DMRS variation is (e.g., was mostly likely) transmitted and/or implicitly decode the SS-Block ID. The receiver may not have to wait for a whole PBCH to be decoded to find the SS-Block ID. The ways to accomplish an implicit SS block index indication may be described herein.

An DMRS sequence may use multiple (e.g., two) m sequences multiplied or XORed with each other. M sequences (e.g., the two m sequences) may be generated by predetermined models, function, and/or equations (e.g., polynomials). For example, two different cyclic shifts (e.g., m0 and m1) for the two m-sequences may be used. The two m sequences may be XORed to generate a gold sequence. The resulting sequence(s) may be BPSK modulated and/or may be repeated or truncated to fill some or all DMRSs. If the length of the m sequence(s) is 31 (e.g., which may be repeated), a combination of models, functions, and/or equations (e.g., polynomials) may be used. The m sequence(s) (e.g., an XORed m sequence(s)) may be repeated. For example, a relatively short m sequence(s) may be repeated to construct a relatively long sequence. Eq. 3, 4, and 5 may be examples of the polynomials.

g(x)=x5+x2+1 Eq. 3

g(x)=x5+x4+x3+x2+1 Eq. 4

g(x)=x5+x4+x2+x+1 Eq. 5

Other polynomials (e.g., irreducible primitive polynomials) may also be used.

If the length of m sequences is 63 (e.g., for higher density DMRSs), a combination of models, functions, and/or equations (e.g., polynomials) may be used. Eq. 6, 7, and 8 may be examples of the polynomials.

g(x)=x⁶+x+1 Eq. 6

g(x)=x⁶+x⁵+x²+x+1 Eq. 7

g(x)=x⁶+x⁵+x³+x²+1 Eq. 8

Other polynomials (e.g., irreducible primitive polynomials) may also be used.

A combination of functions (e.g., m0 and m1) may be used to indicate an SS block index. Table 1 may be example of a combination of functions m0 and m1. If the number of SS blocks is 4, 8 and 64, four, eight and sixty-four combinations (e.g., m0, m1) may be used (e.g., required) to indicate an SS block index respectively as shown in Table 1.

TABLE 1

| | | # of m combinations of m0 and |
|---|---|---|
| | # of bits | m1) |
| | (e.g., if explicit | (e.g., if implicit indication is |
| L (# of SS blocks) | indication is used) | used) |
| 4 | 2 | 4 |
| 8 | 3 | 8 |
| 64 | 6 | 64 |

A secondary NR-PBCH design may be provided. A secondary NR-PBCH may be used to assist NR-PBCH for system information transmission.

A secondary NR-PBCH scheme may be used. NR-PBCH may carry the first part of minimum system information e.g., PHICH information, etc. A WTRU may decode NR-PBCH. A secondary NR-PBCH may carry the second part of minimum system information, e.g., RACH configuration, paging information, etc. A secondary NR-PBCH may be used to assist NR-PBCH for system information transmission, e.g., as shown in FIG. 34.

FIG. 34 is an example of a secondary NR-PBCH assisting NR-PBCH to acquire minimum system information. A WTRU may decode secondary NR-PBCH, for example, to obtain scheduling information and RACH configuration information for other SIBs. A WTRU may decode NR-PDCCH/NR-PDSCH for other SIBs (e.g., to obtain other system information), for example, with assistance of scheduling information decoded by secondary NR-PBCH.

A secondary NR-PBCH Transmit structure may employ a Polar encoding scheme, which may provide a performance enhancement. Polar codes may provide better gain, e.g., for small payload size. Polar codes may be systematic or non-systematic Polar codes. Parity check (PC)-based Polar codes may (e.g., also) provide good performance. A dB gain achievable by Polar codes may, for example, enable a secondary NR-PBCH to accommodate a few more bits. Extra bits may be used, for example, to carry additional system information, beam or antenna configuration information, such as an indication for TX/RX beam reciprocity, beam operation modes (e.g., single/multi-beam) for indication or confirmation, etc. Polar codes may be optimized for secondary NR-PBCH transmission.

A performance gain may be achieved, for example, when Polar encoding is used to transmit system information, e.g., for secondary NR-PBCH.

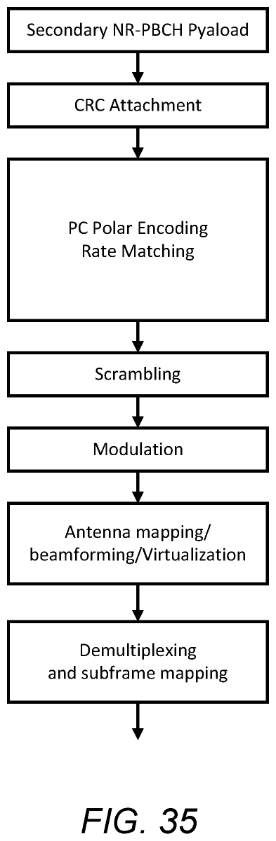

FIG. 35 is an example of a secondary NR-PBCH transmission. A BCH transport block or secondary NR-PBCH payload may be attached with CRC. An NR-BCH payload and CRC may be encoded, for example, using a Polar encoder or PC Polar codes. A rate match (RM) may be performed for the coded bits. The coded bits (e.g., after rate matching) may be scrambled by a scramble code. The coded bits (e.g., after RM and scrambling) may be modulated. Antenna mapping, beamforming, virtualization, de-multiplexing and subframe mapping may be performed.

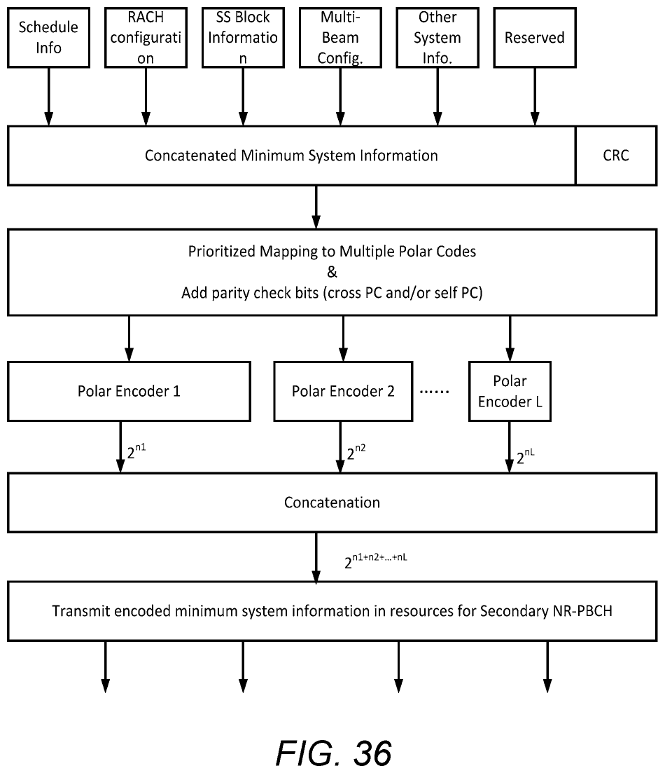

Some deep puncturing may (e.g., severely) degrade the performance of polar codes. A rate matching scheme may be used, e.g., as an alternative to puncturing, which may improve coding performance. An example is shown in FIG. 36.

FIG. 36 is an example of secondary NR broadcast channel coding. Multiple polar codes with different lengths may be used, e.g., compared to using a single polar code. In an example, L polar codes may be used. The i-th polar code may have a codeword length 2ⁿ^{ᵢ}, where 1≤i≤L. The selection of L and n₁, . . . , n_{L} may depend on a desired coded block length of secondary NR-PBCH in a (e.g., each) radio frame. In an example, X resource elements may be allocated for secondary NR-PBCH in a (e.g., each) radio frame. QPSK modulation may be used. A coded block length of PBCH may be 2× bits. M polar codes with proper codeword lengths may be selected to accommodate a suitable number of bits.

Prioritized mapping to a multiple polar codes block may be considered to be a matrix production operation. In an example, an input to the block may be a vector A of t bits. The output of the block may be Σᵢ₌₁^{L}nᵢ, which may match L polar codes of lengths n₁, . . . , n_{L}. The block may be a matrix W of size t×Σᵢ₌₁^{L}nᵢ. The output may be calculated as A·W in GF(2) field. The design or creation of a matrix W may consider the importance of the input bits. For example, the first n₁ bits of the outputs may be encoded by polar code 1 with length n₁ while the next n₂ bits of the outputs may be encoded by polar code 2 with length n₂, etc. The outputs of L polar codes may be concatenated. The concatenated bits may be scrambled and modulated to fit in a secondary NR-PBCH channel of a radio frame. The same secondary NR-PBCH data may be repeated for some radio frames.

Multi-beam implementation(s) using an initial UL transmission may be provided. An initial uplink transmission may provide, for example, one or more of the following: (i) a response to a beam (e.g., ACK to beam to provide WTRU beam-location profile), which may be used, for example, to enable DL selective beam sweep; (ii) feedback of a desired DL beam (e.g., a widebeam), which may be used, for example, to enable DL hierarchical beam sweep to perform narrow beam sweep within a widebeam; (iii) feedback of a DL beam pair link or link set and/or (iv) WTRU beam correspondence or beam reciprocity information, which may be used, for example, to determine a TRP Tx beam and/or indicate a WTRU Rx beam for a subsequent DL signal or channel transmission, e.g., transmission of response to initial UL and subsequent system information transmission.

An initial uplink transmission may be used to enable a subset of a beam transmission and/or hierarchical beam sweeping. One or more of the following may be performed.

NR-PBCH may perform beam sweeping in multiple (e.g., all) directions. NR-PBCH may use one or more first stage beams for beam sweeping. In examples, a first stage beam may be a widebeam and a second stage beam may be a narrow beam. In examples, a first stage may be a low resolution beam and a second stage may be a high resolution beam. NR-PBCH may be used, for example, to signal beam correspondence or reciprocity information to a WTRU.

An initial UL transmission may serve as WTRU feedback and may provide an ACK to beam for obtaining a beam-location profile of WTRUs. An initial UL transmission may (e.g., also) provide the best or desired one or more first stage beams (e.g., widebeam or low resolution beam) in one or more hierarchical beam sweeping procedures. An initial UL transmission may (e.g., also) provide beam correspondence or beam reciprocity information.

System information and/or a DL response to initial UL transmission may be performed using, for example, selective beam sweep, e.g., based on a WTRU beam-location profile. System information transmission and/or a DL response to initial UL transmission may be performed, for example, by using a second stage beam (e.g., narrow beams or high resolution beams) within the best or desired first stage one or more beams, e.g., with or without using selective beams or selective beam sweeping.

Features, elements and actions (e.g., processes and instrumentalities) are described by way of non-limiting examples. While examples are directed to LTE, LTE-A, New Radio (NR) or 5G specific protocols, subject matter herein is applicable to other wireless communications, systems, services and protocols. Each feature, element, action or other aspect of the described subject matter, whether presented in figures or description, may be implemented alone or in any combination, including with other subject matter, whether known or unknown, in any order, regardless of examples presented herein.

Systems, methods, and instrumentalities have been disclosed for NR-PBCH, initial uplink (UL) transmission and system acquisition in NR, including procedures for system acquisition, initial UL transmission, cell ID detection, indicating an SS-block Index and determining subframe timing.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, terminal, base station, RNC, and/or any host computer.

What is claimed:

1. A wireless transmit receive unit (WTRU) comprising:
a processor configured to:
receive a first part of minimum system information (MSI), wherein the first part of MSI comprises a sub-carrier-spacing (SCS) indication associated with a second part of MSI;
receive the second part of MSI, wherein the second part of MSI comprises:
a physical random access channel (PRACH) request format indication, wherein the PRACH request format indication comprises:
a PRACH preamble,
an SCS indication for a PRACH preamble, and
an orthogonal cover code (0CC) indication, wherein on a condition that the OCC indication indicates that OCC is enabled, the second part of MSI further comprises an OCC length; and
transmit a PRACH request, wherein a configuration associated with the PRACH request is determined based on one or more indications, wherein the one or more indications comprise a PRACH request format indication.

2. The WTRU of claim 1, wherein on a condition that the OCC indication indicates that OCC is enabled, the one or more indications further comprise a SCS indication for the PRACH preamble.

3. The WTRU of claim 1, wherein the second part of MSI further comprises an SCS indication for a random access channel (RACH) message 3.

4. The WTRU of claim 1, wherein the configuration associated with the PRACH request comprises:
a first configuration on a condition that OCC is disabled; or
a second configuration on a condition that OCC is enabled.

5. The WTRU of claim 4, wherein the first configuration comprises:
a plurality of preamble sequences, wherein the plurality of preamble sequences comprises a preamble sequence that is repeated,
a cyclic prefix (CP), wherein the CP is inserted before each of the plurality of preamble sequences, and
a guard time (GT), wherein the GT is inserted after a last preamble sequence.

6. The WTRU of claim 4, wherein the second configuration comprises:
a plurality of preamble sequence instances, wherein the plurality of preamble sequence instances comprises:
a first preamble sequence type, and
a second preamble sequence type;
a CP, wherein the CP is inserted before each of the plurality of preamble sequence instances;
at least one orthogonal cover code (0CC) associated with the first preamble sequence type and the second preamble sequence type; and
a GT, wherein the GT is inserted after a last preamble sequence instance associated with the plurality of preamble sequence instances.

7. The WTRU of claim 6, wherein in the second configuration there are a plurality of instances of the first preamble sequence type and a plurality of instances of the second preamble sequence type.

8. The WTRU of claim 7, wherein the plurality of instances of the second preamble sequence type follows the plurality of instances of the first preamble sequence type.

9. The WTRU of claim 6, wherein there is a first OCC code associated with the first preamble sequence type and a second OCC code associated with the second preamble sequence type.

10. The WTRU of claim 9, wherein the first OCC code and the second OCC code have different lengths.

11. A method comprising:
receiving a first part of minimum system information (MSI), wherein the first part of MSI comprises a sub-carrier-spacing (SCS) indication associated with a second part of MSI;
receiving the second part of MSI, wherein the second part of MSI comprises:
a physical random access channel (PRACH) request format indication, wherein the PRACH request format indication comprises:
a PRACH preamble,
an SCS indication for a PRACH preamble, and
an orthogonal cover code (0CC) indication, wherein on a condition that the OCC indication indicates that OCC is enabled, the second part of MSI further comprises an OCC length; and
transmitting a PRACH request, wherein a configuration associated with the PRACH request is determined based on one or more indications, wherein the one or more indications comprise a PRACH request format indication.

12. The method of claim 11, wherein on a condition that the OCC indication indicates that OCC is enabled, the one or more indications further comprise a SCS indication for the PRACH preamble.

13. The method of claim 11, wherein the configuration associated with the PRACH request comprises:
a first configuration on a condition that OCC is disabled; or
a second configuration on a condition that OCC is enabled.

14. The method of claim 13, wherein the first configuration comprises:
a plurality of preamble sequences, wherein the plurality of preamble sequences comprises a preamble sequence that is repeated,
a cyclic prefix (CP), wherein the CP is inserted before each of the plurality of preamble sequences, and
a guard time (GT), wherein the GT is inserted after a last preamble sequence.

15. The method of claim 13, wherein the second configuration comprises:
a plurality of preamble sequence instances, wherein the plurality of preamble sequence instances comprises:
a first preamble sequence type, and
a second preamble sequence type;
a CP, wherein the CP is inserted before each of the plurality of preamble sequence instances;
at least one orthogonal cover code (OCC) associated with the first preamble sequence type and the second preamble sequence type; and
a GT, wherein the GT is inserted after a last preamble sequence instance associated with the plurality of preamble sequence instances.
